(19) United States
(12) Patent Application Publication
(10) Pub. No.: US 2010/0138362 A1
(43) Pub. Date: Jun. 3, 2010

(54) Methods and Systems For Commoditizing Interest Rate Swap Transfers

(75) Inventor: Philip H. Whitehurst, London (GB)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: DeltaNet Market Limited

(21) Appl. No.: 12/621,412

(22) Filed: Nov. 18, 2009

Related U.S. Application Data
(63) Continuation-in-part of application No. 11/387,974, filed on Mar. 24, 2006, now abandoned.
(60) Provisional application No. 60/714,424, filed on Sep. 6, 2005.

(51) Int. Cl. G06Q 40/00

(52) U.S. Cl. 705/36 R; 705/37

(57) ABSTRACT

A method, system, and financial products for trading a commoditized claim. The claim obligates one party to pay on demand to a second party an amount, for value rolling spot, transparently determined with reference to a market quote for spot-starting benchmark interest rate swap contracts of pre-specified tenor. The claim is denominated in terms of the sensitivity of present value to a one basis point yield change (“PV01”). The claim may be a debt obligation of a third-party and may be open-ended. Embodiments of the claim closely replicate interest rate swap risk profiles and permanently track benchmark quotes, and do so within a simplified operational framework. There is a linear intra-day and index-linked overnight relationship between (i) the market rate for the pre-specified grid-point constant maturity swap and (ii) the payment obligation. Securitized, bilateral, OTC and futures contract embodiments are disclosed.

### RELATED APPLICATION

The present application is a continuation-in-part application of and claims the benefit of and priority to application Ser. No. 11/387,974 entitled “Methods and Systems for Commoditizing Interest Rate Swap Risk Transfers,” filed Mar. 24, 2006, which claims priority from provisional application No. 60/714,424, filed on Sep. 6, 2005, and are hereby incorporated by reference.

### FIELD

The present invention relates to the field of interest rate risk management. A number of financial products are available to market participants for managing this risk, one of which is the Interest Rate Swap (“IRS”). IRSs are used to manage cashflow risk and net present value (“NPV”) risk. The present invention enlarges the set of IRS-based financial products available to managers of NPV risk. Through the method and system described herein, market participants are able to buy and sell IRS quotes as a tradable investment instrument.

### BACKGROUND

IRSs are long-term bi-lateral contracts in which one party pays a fixed rate periodically in exchange for receiving a floating rate from a second party.

FIG. 1A illustrates key elements of the environment supporting trade activity. The swap market is defined by quotes Li_{q} 28B/28A for grid-points “Grid-Point IRS” along the yield curve for currency GIDC 50, which have a constant maturity K 40 relative to the prevailing trade date fₛᵢ 14. Suppliers PM 10 quote in terms of the fixed rate they will pay 28B (in exchange for receiving the floating rate) or receive 28A (in exchange for paying the floating rate).

Ahead of trading, the template for contracts at each grid-point can be defined by a series of methods and conventions. An FpML® template typically involves more than 50 parameters which can be summarised as Quotation Basis (QB) 27.

For execution against a Supplier's quote, a Counterparty (PT) 15 identifies itself and the notional amount (N) 13 it wishes to trade. Subject to mutual credit acceptance, this additional information allows the template to be converted into an executable contract.

On a given day at each grid-point, of the parameters required for a full FpML® specification, executed contracts typically differ by four items 10, 15, 13, 28E. As a result, the small set of quotes act as the gateway into a much greater set of individual contracts. Moreover, on subsequent days, the same small set of quotes continue to act as gateways, but they lead into contracts with a new date schedule driven by new trade date fₛⱼ 31.

So, although this usefully small & stable quote set appear to operate as an efficient route into swap contracts, we note two problems with the current IRS market:

First, trades executed on different dates have different templates and second, trades executed on the same date have distinct fixed cashflow schedules. This results in IRS instruments which are not fungible; either at another rate or an earlier term date. In other words, once a market participant acquires an IRS contract, the market participant does not automatically eliminate its position by executing an offsetting transaction even, at cost to immediate trading efficiency, it goes to the elaborate lengths of matching the notional amount, the date schedule and the fixed rate of the original (e.g. by contrast, in an open stock-marketplace, market participants are free to buy, sell and trade stock without restriction in which offsetting trades automatically net down to the difference in invoice prices). It may only transfer that contract before contract term is up by a process of novation, requiring the consent of its original counterparty. As a result, market participants often acquire new IRS contracts rather than offload old ones as a matter of short-term convenience.

This lack of instrument fungibility has a number of costs; directly in terms of unit processing and portfolio risk management and indirectly in terms of price opacity.

In terms of portfolio risk management, a proliferation of gross notional amounts leads to lower risk transparency; a greater risk calculation, reconciliation and reporting workload (therefore more error-prone); a requirement for potentially excessive regulatory capital against credit and operational risks; to an excess of collateral in circulation; and to inefficient use of credit lines between parties.

In terms of unit processing, individual confirmations are more costly, record-keeping is more demanding, and secondary trades (buy-outs and assignments) are more time-consuming and expensive.

The price opacity has led to constraints on instrument use by regulators, largely because of more onerous revaluation procedures, and to unfavourable accounting treatment.

Therefore, a method and system for trading a commoditized financial claim which allows market participants to retain an attractive small spot Grid-Point IRS quote array but which lead participants transparently into fungible trading units is useful.

### SUMMARY

A method, system and financial products for trading fungible interest rate swap risk redenomination products are disclosed. According to one embodiment, a first party executes a first transaction in a financial product over an electronic trading system with a second party in exchange for a fixed cash amount. In the first transaction, the first party and second party agree on the identity, the amount, and price of the financial product, wherein the amount of the financial product is set in terms of its value sensitivity to a one basis point movement in the quoted rate for a single generic instrument, and the price bears a direct linear relationship to an executed rate being the rate quoted by the second party for the single generic instrument. The electronic trading system determines all subsequent real-time values of the financial product and/or position in the financial product. At the close of business in preparation for trading of the financial product the next day, either adjusting the fixed rate of the product applicable for the settlement date, or leaving the fixed rate of the position in the product as that applicable for the settlement date. The first party executes a second transaction in the financial product over an electronic trading system with the second party or a third-party in exchange for a second fixed cash amount, where in the second transaction offsets the first transaction.

### BRIEF DESCRIPTION OF THE DRAWINGS

The accompanying drawings, which are included as part of the present specification, illustrate the presently preferred embodiment of the present invention and together with the general description given above and the detailed description of the preferred embodiment given below serve to explain and teach the principles of the present invention.

FIG. 1A illustrates a schematic diagram of IRS trade execution as conducted on automated electronic platforms, and the financial contracts which result.

FIG. 1B illustrates a block diagram of exemplary computer architecture for use with the present system, according to one embodiment.

FIG. 1C illustrates a block diagram of a computer system for electronically trading present financial products, according to one embodiment.

FIG. 2A illustrates key stages involved in the method of evaluating the Forward Swap Premium SNIF_{i,K}.

FIG. 2B illustrates a flow diagram of attributes, methods and formulas for calculating the CC component of UDPI.

FIG. 2C is a flow diagram illustrating the attributes, methods and formulas for calculating the QC component of UDPI.

FIG. 2D is a flow diagram illustrating the attributes, methods and formulas for calculating the Convexity Basis applicable for converting Grid-Point IRS quotes into UDP quotes.

FIG. 2E is a flow diagram illustrating the attributes, methods and formulas for calculating the Generated IRS terms and balancing payment applicable when exchanging a CDP position for physical IRS (EfP) within CCP infrastructure capable of handling IRS, and when exchanging for cash (EfC).

FIG. 2F is a schematic instrument taxonomy, expressed in terms of the value components which account for the inter-day spot rate tracking.

FIG. 3A illustrates tabulated pay-off and product accounting parameters by instrument type.

FIG. 3B tabulates preferred margin configurations for SNIPn-regimes, across market rate scenarios and instruments. Margins are expressed from an end-user's perspective.

FIG. 3C tabulates attributes Notional Asset Value and Notional Invoice Amount by instrument type.

FIG. 3D illustrates tabulated default ticket data by instrument type.

FIGS. 4A and 4B illustrate examples of UDPI and derived index (e.g. SFA) display screens.

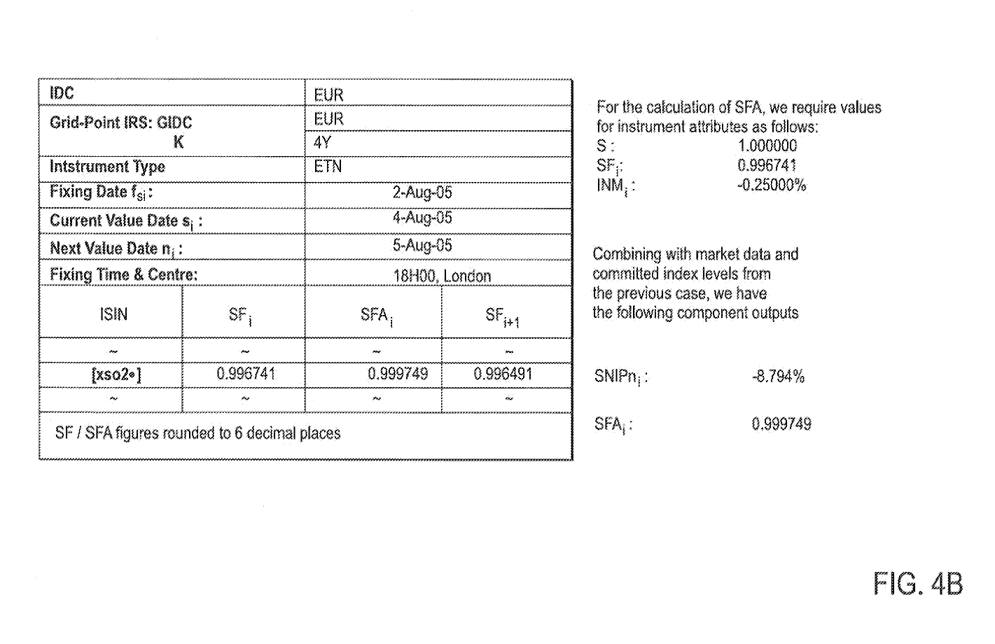

FIG. 4C illustrates the deployment of the SNIPn index in trading Cash Delta Point instruments.

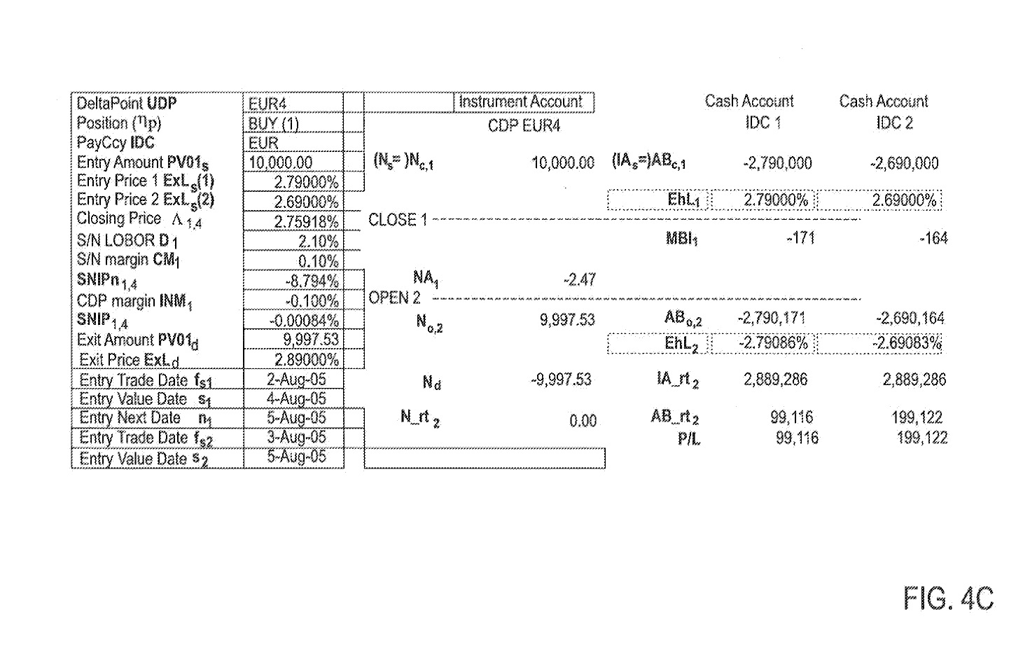

FIG. 5A illustrates example windows leading to execution of bi-lateral instruments (e.g. OIS) of the present invention over an electronic platform integrated with IRS execution.

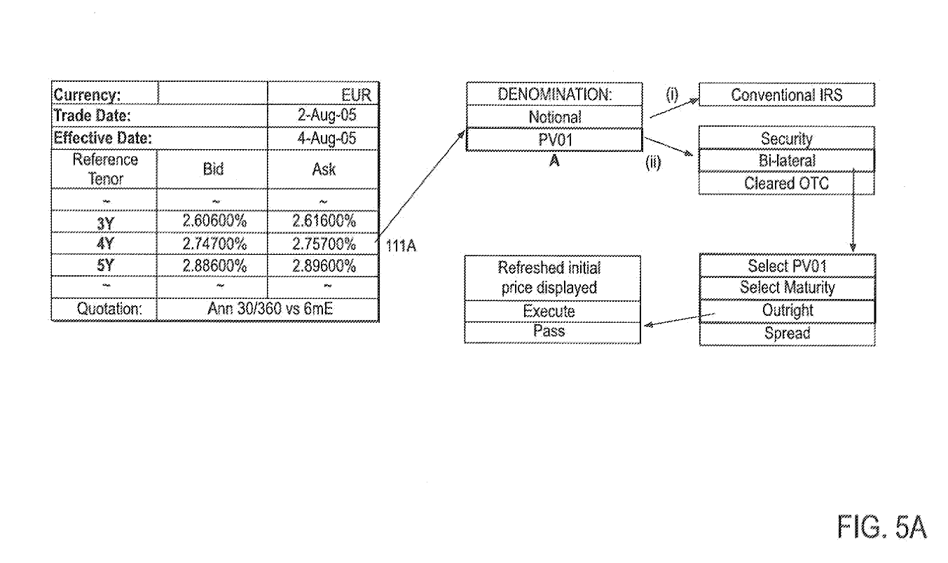

FIG. 5B illustrates example windows relating to execution of SNIPn-driven CDP over an electronic platform integrated with spot foreign exchange execution.

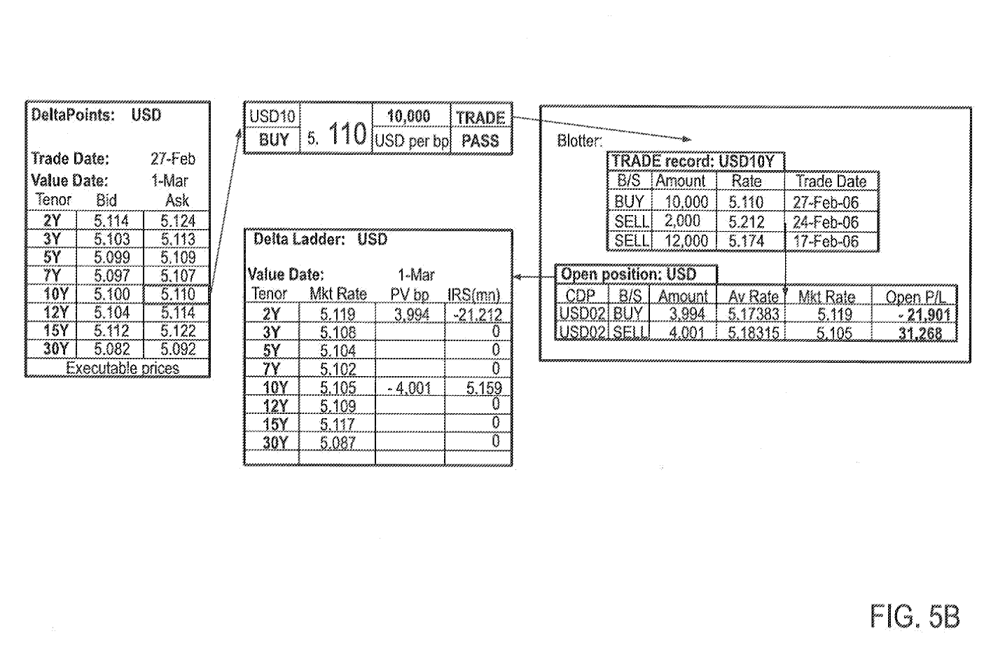

FIG. 6 illustrates example transaction tickets for CDP and ETN embodiments of the present invention, including the PV01/Notional toggle for CDP (constrained by unit size for ETN).

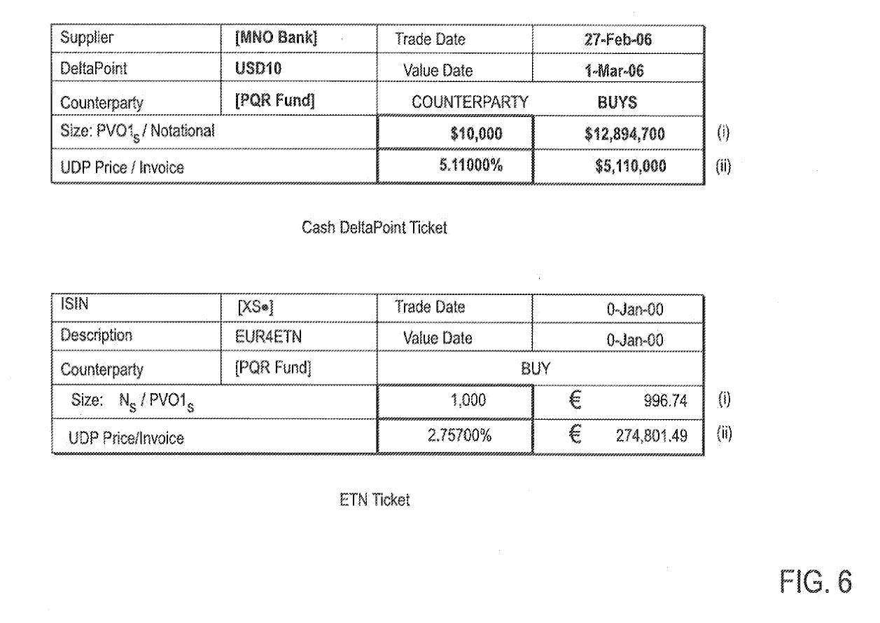

FIG. 7A illustrates a novel instrument display structure for Cash Delta Points, allowing co-ordinate sensitive display to aid performance evaluation and subsequent execution.

FIG. 7B illustrates An example of price display panel for CDP which participants can view pre-execution CDP instrument data.

FIG. 8 illustrates tabulated primary exit processes from present investment instruments into cash payments, into alternative present investment instruments and into Generated IRS.

FIG. 9A illustrates an example display configuration for present investment instrument windows and first order risk report, alongside example index series data wherein the risks are reported from an IntraDay perspective.

FIG. 9B illustrates an example display configuration for present instrument windows and first order risk report, alongside example index series data wherein the risks are reported from an Overnight perspective.

FIG. 9C illustrates the first order risk report displayed in FIG. 9B along with additional second order risk data.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings described herein and do not limit the scope of the claims.

### DETAILED DESCRIPTION

A method and system for trading fungible interest rate swap risk redenomination products is disclosed. According to one embodiment, a computer implement method of trading fungible interest rate swap risk redenomination products comprises executing a first transaction in a financial product (hereinafter “financial product” or “product”) by a first party with a second party in simultaneous exchange for a first fixed cash amount. The first party and the second party conduct the transaction over an electronic trading system. The first party and the second party agree directly or indirectly at the execution of this first transaction the identity of the product, the executed amount of the product denominated as its value sensitivity to a one basis point movement in the quoted rate for a single generic instrument, the executed price of the product, whether the first party is the buyer or the seller of the product and the settlement date of the transaction. The first party and the second party exchange their settlement instructions in order to settle the transaction. The executed price bears a direct linear relationship to an executed rate, being the rate quoted at execution by the second party for said single generic instrument. The first party, as a result of this first transaction, initiates an open position in the product which is potentially open-ended. All subsequent real-time values of the product and/or position in the product may be determined by interested parties by multiplying the prevailing amount of the product with the sense of the product and with the arithmetic difference between the prevailing rate quoted for said single generic instrument and a fixed rate, each with a polarity according to the respective parties' position in the product. At the close of business in preparation for trading of the product the next day, either: adjusting the fixed rate of the product applicable for the settlement date of the first transaction by applying a contractually-binding daily-reset index value to the fixed rate within a contractually-binding formulation; or applying cash adjustments using a contractually-binding daily-reset index value within a contractually-binding formulation to a parallel cash account operated in support of position in the product while leaving the fixed rate of the position in the product as that applicable for the settlement date of the first transaction. The first party executes a second offsetting transaction in the product with the second party or with a new third party in exchange for a second fixed cash amount without reference to the first transaction. The first party and its trading partner agree directly or indirectly at the execution of this second transaction the identity of the product being the same as in the first transaction, the executed amount of the product being the same as the prevailing amount derived from the executed amount of the first transaction, the second executed price of the product and the settlement date of the transaction, with the first party taking the position of buyer or seller of the product opposite to that which it took in the first transaction. The executed price of the product in this second transaction bears a direct linear relationship to the prevailing rate quoted by the trading partner for said single generic instrument. The first party and its trading partner exchange their settlement instructions in order to settle the second transaction. The first party, as a result of this second transaction, eliminates its position in the product. The first party determines the combined profitability of the transactions as the sum of balance changes in any cash account(s) which has(have) received or made payments in association with the two transactions or their immediate consequences.

The financial products obligate one party to pay on demand to a second party an amount, for value rolling spot, transparently determined with reference to a market quote for spot-starting benchmark interest rate swap contracts of pre-specified tenor. The financial products are denominated in units of PV01. The financial products may be debt obligations of a third party and may be open-ended. The financial products may be converted into conventional IRS under contractually binding terms. Embodiments of the claim closely replicate IRS risk profiles and permanently track benchmark quotes, and do so within a simplified operational framework. There is a linear intra-day and index-linked overnight relationship between (i) the market rate for the pre-specified grid-point constant maturity swap and (ii) the payment obligation.

For the orderly functioning of today's financial markets, participants rely on many frameworks and conventions which overlay one another. It is thus an object of this invention to operate (and be operated) within existing frameworks. The conventional infrastructure on which individual instrument types rely is noted, but discussion here is limited to those elements of the present invention which extend conventional frameworks, or modify them in ways which are not obvious.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein. Terms used in the following description are provided in the Notation and Glossary sections of the specification. Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. A method is here, and generally, conceived to be a self-consistent process leading to a desired result. The process involves physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the method and system as described herein.

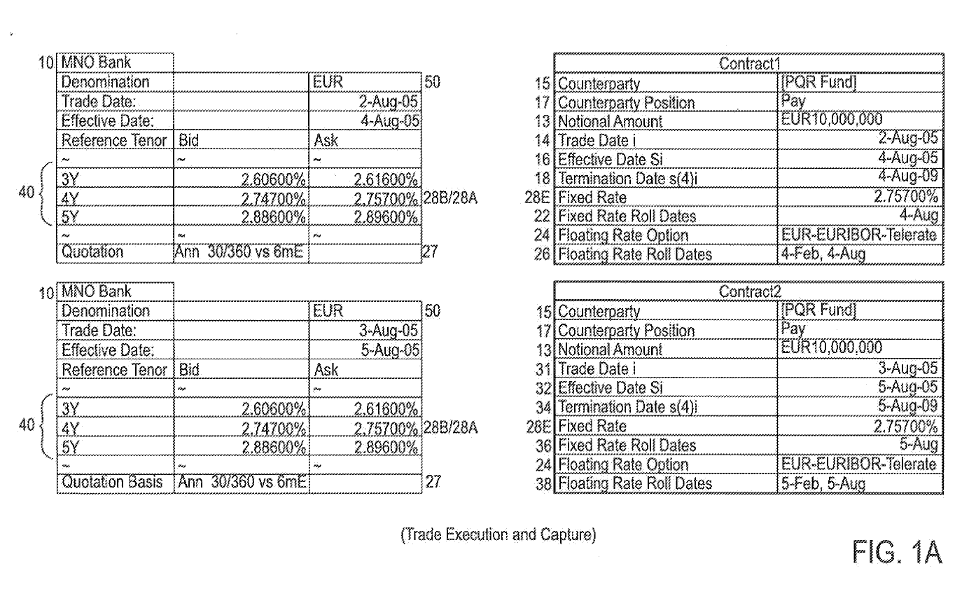

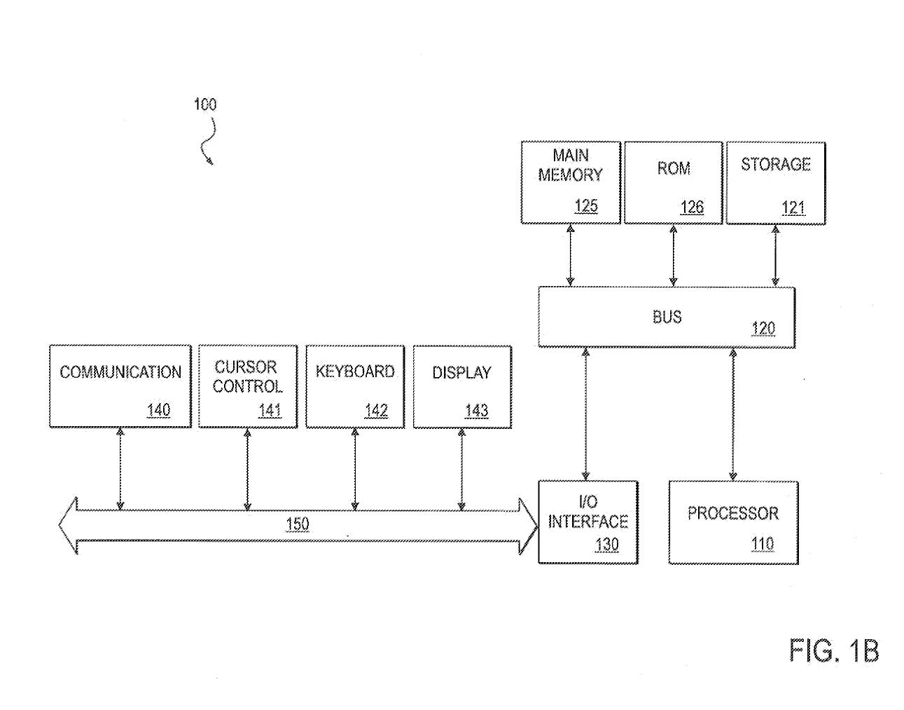

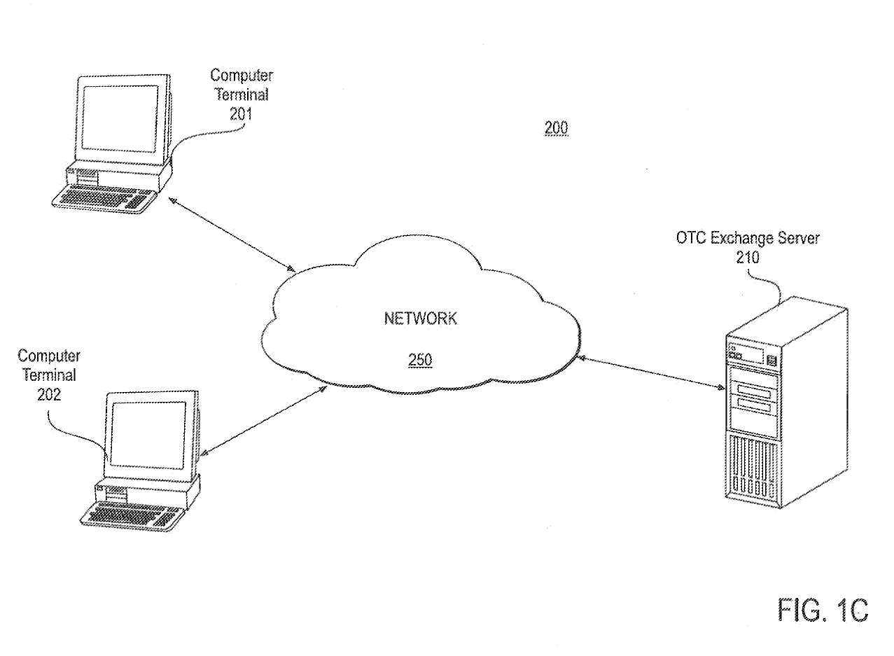

FIG. 1B illustrates a block diagram of exemplary computer architecture for use with the present system, according to one embodiment. Architecture 100 comprises a system bus 120 for communicating information, and a processor 110 coupled to bus 120 for processing information. Architecture 100 further comprises a random access memory (RAM) or other dynamic storage device 125 (referred to herein as main memory), coupled to bus 120 for storing information and instructions to be executed by processor 110. Main memory 125 also may be used for storing temporary variables or other intermediate information during execution of instructions by processor 110. Architecture 100 also may include a read only memory (ROM) and/or other static storage device 126 coupled to bus 120 for storing static information and instructions used by processor 110.

A data storage device 127 such as a magnetic disk or optical disc and its corresponding drive may also be coupled to computer system 100 for storing information and instructions. Architecture 100 can also be coupled to a second I/O bus 150 via an I/O interface 130. A plurality of I/O devices may be coupled to I/O bus 150, including a display device 143, an input device (e.g., an alphanumeric input device 142 and/or a cursor control device 141).

The communication device 140 allows for access to other computers (servers or clients) via a network. The communication device 140 may comprise one or more modems, network interface cards, wireless network interfaces or other well known interface devices, such as those used for coupling to Ethernet, token ring, or other types of networks.

FIG. 1C illustrates a block diagram of a computer system for electronically trading present financial products, according to one embodiment. System 200 includes computer terminals 201 and 202, and OTC exchange server 210. System 200 is interconnected by network 250. According to one embodiment, network 250 is described as being the Internet, alternatively, network 250 may be a Wide Area Network (WAN), a Local Area Network (LAN), or any other system of interconnections enabling two or more devices to exchange information.

Computer terminals 201 and 202 are based on architecture 100 described in FIG. 1B. Participants connect to OTC exchange server 210 via computer terminals 201 and 202 through a trading interface. Instrument calculations described herein are performed by OTC exchange server 210. Computer terminals 201 and 202 logged onto OTC exchange server can send and receive trade data related to present financial products. For example, the trade data may include instrument identifier, the trading partners, their respective positions, the size, the execution price, the trade date and the settlement date. Upon viewing the trade information, participants can execute transactions between each other. System 200 could be an auction system, cross-matching system, inter-dealer system, multi-dealer systems or single-dealer system. Further optional embodiments exist in which the risk exchange is in bi-lateral form.

According to one embodiment, the method and system facilitates trading of fungible IRS-based financial products through a two-fold process of digitisation. Exemplary embodiments of said financial products are described in Appendix 09.

The passage of time is sliced into daily units, to match the rate of template change. The yield curve is sliced into discrete points known as Underlying Delta Points (UDPs) to match the quote array. Novel methods, factors and adjustments of the present invention fully identify operational mechanisms and executable products which enable risk transfer using said digitisation.

To lift fungibility from the cashflow level (of IRS) to the instrument level (of UDP-based instruments), UDPs as discrete commodities feature two key characteristics which distinguish them from IRSs: i) a change of denomination and ii) a novel financing rate.

In a first inventive step, the IRS contract is subject to redenomination. The use of notional amount to denominate IRS is superseded by the use of NPV sensitivity (“sensitivity of present value to a 1 basis point yield change” or “PV01”) to denominate the present financial products. While IRS trading is sometimes conducted in terms of PV01, it is always translated into a notional amount for production of the contract. By contrast, in the present invention the contractual denomination is set in terms of PV01.

Further sub-steps are necessary to handle the impact of this denomination change and discussed in detail bellow. These include introduction of an intra-day convexity basis, an intra-day fixing basis and an optional intra-day quanto basis. These bases are applied to live IRS rates to transforms them into live UDP rates.

In a second inventive step, PV01 risk on a first day must be connected with PV01 risk on a second day. This linkage is achieved via UDP indices (UDPIs) which operate as financing rates. These factors are published once daily per financing period per UDP. According to one embodiment, the financing period is one business day, but other periods are equally valid.

In further sub-steps, to enable deployment of the present method within the widest range of products, the return per unit of PV01 risk may be expressed in one of three ways: as taught in application Ser. No. 11/387,974, dated 24 Mar. 2006, to a parallel cash account either as an amount (SNIP) or as a rate (SNIPR), or as taught herein as an adjustment to the PV01 account (SNIPn).

As a result, the financial products can be open-ended, spot-settled instruments. Trading in the financial products can take place via simpler tickets, which require buyer and seller to be identified, UDP(s) (or instrument referencing the UDP(s)) to be identified, size expressed in PV01 and price expressed as live UDP quote. These tickets are automatically fungible, a significant improvement over conventional IRSs. This fungibility applies not only to activity conducted within a trading day, but extends to include activity on different days.

These features resolve many of the problems of the convention IRS marketplace, including, but not limited to, improved efficiency, reduced processing costs, and improved transparency.

Portfolio size is held in check, meaning that collateral in circulation can be reduced and that regulatory capital for operational and for credit risks may be smaller in aggregate. Credit lines are used more efficiently, with the additional benefit that spot settlement of present instruments reduces the term of necessary line.

Unit processing costs are reduced, standardisation forces common data out of the ticketing process, which is then cheaper; revaluation is much simpler and more direct; and a genuine secondary market emerges, thereby improving efficiency.

Improved transparency, and the use of benchmark indices, will improve the classification of trading activity for regulators and for accounting bodies.

### UDP Commodity

As discussed above, a UDP commodity forms a basis of the different embodiments of the Financial products. These embodiments are discussed individually in detail but first we discuss the common attributes on which the individual embodiments draw.

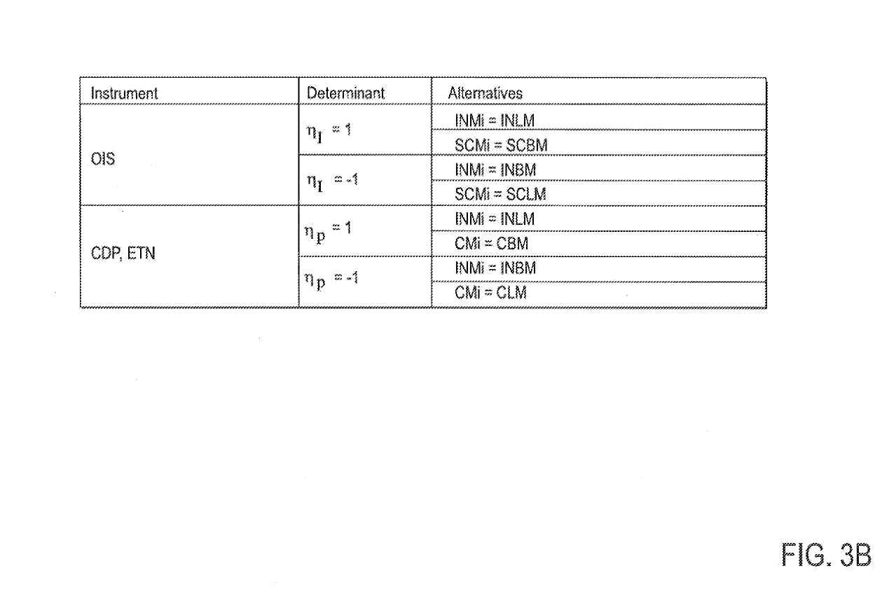

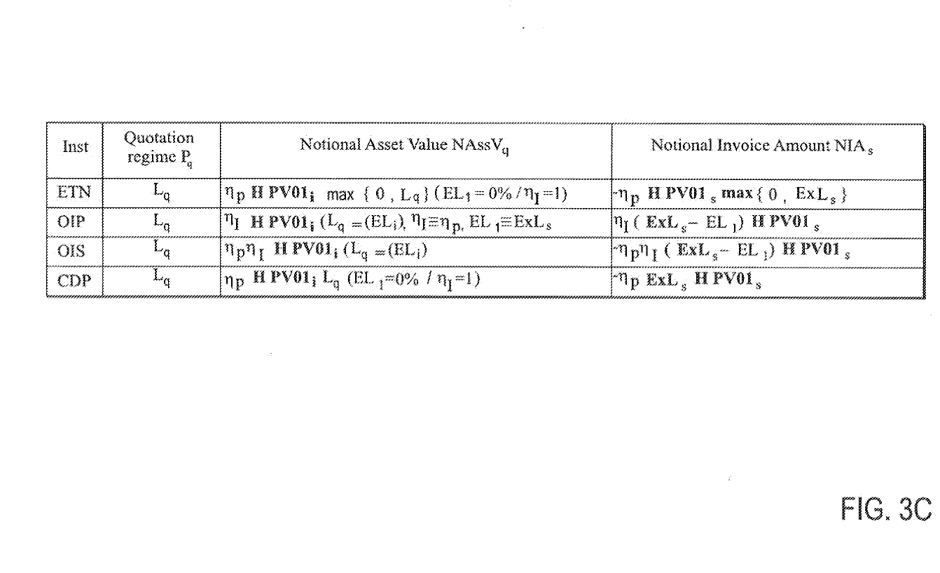

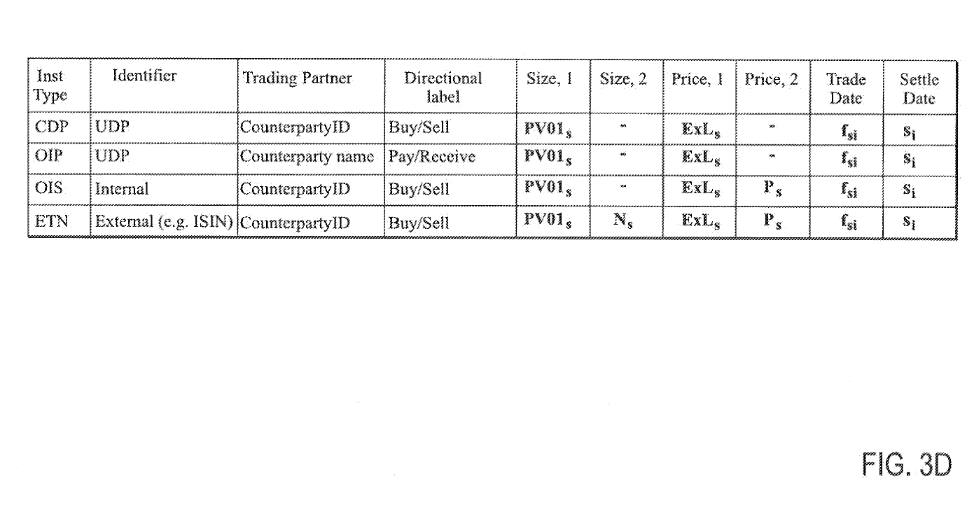

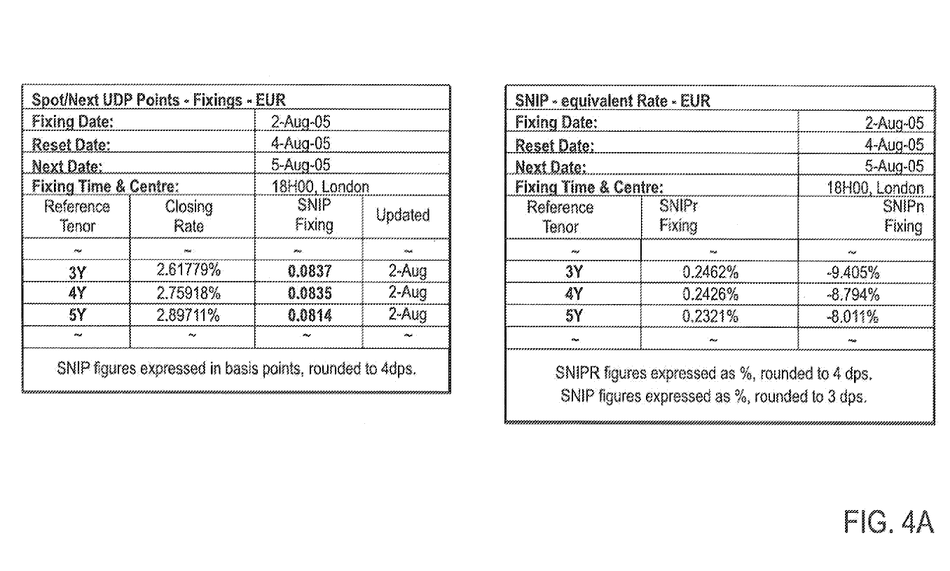

The value of the fungible instruments AssV_{q} or positions in the fungible instruments V(T)_{q} can be expressed as a function of two variables: live UDP quote(s) L_{q,K} and break-even ELᵢ (for instruments) or EhLᵢ (for positions in instruments). Expressions per instrument embodiment are given in FIG. 3C read with additional parameters from FIG. 3A.

Instrument prices P_{q} are anchored around instrument values V_{q} due to the daily, or in the case of certain embodiments continuous, exchangeability & termination features.

The two variables above have loose parallels in conventional swaps. Live UDP quote L_{q,K} is akin to the floating leg, while the break-even ELᵢ is akin to the fixed leg. However, in the conventional swap system, we need to use a full input curve and a fully-configured pricing engine to derive instrument value as the difference between leg NPVs; it cannot be expressed as a simple and transparent function of its inputs. This contrasts with the isomorphism between live UDP quote L_{q,K} and instrument price P_{q} present in the present method and system, both for trade entry and trade exit.

### UDP\IRS Basis

There is a basis B_{q,K} (between live UDP quotes L_{q,K} and live Grid-Point IRS quotes Li_{q,K}. See Appendix 01A. In practice, this basis is often zero (at the level of rounding applicable for price submission). In theory, there is one permanent contribution to this basis; a second temporary contribution applies after the Short-Rate Fixing Time. A third contribution applies to quanto instruments. Each contribution equals zero at least once daily. The permanent contribution, the live Convexity Basis CB_{q,K}, is present to account for the redenomination from notional amount for IRS to PV01 for present investment instruments. The temporary contribution, the live Fixing Basis FB_{q,K}, is present to account for absence of a short-rate fixing for the UDP commodity during each daily trading session in contrast to Grid-Point IRS. The third contribution, the live Quanto Basis QB_{q,K}, is present for present instruments for which IDC≠GIDC.

The fact that the basis is in practice often zero, which allows quotes Li_{q,K} and quotes L_{q,K} to be often treated as interchangeable for all but the execution phase, adds greatly to the usefulness of the present products.

Live UDP quotes L_{q,K} may be expressed or presented in basis points (“450.1”) or as percent (“4.501”) as well as taking their strict value in absolute terms (“4.501%”, “0.04501”). System implementations can be easily adjusted for this through the use of scaling factors H (=10,000) and 100 respectively.

### Break-Evan Dynamics

Break-evens ELᵢ for present investment instruments and for positions in present investment instruments EhLᵢ evolve along a step-wise path. According to one embodiment, the time-step for the process is one business day. Break-even is static during a trading session; it is adjusted once daily at the close of each trading session, ready for use from the following open.

The adjustment to the present investment instrument/position is applied on a daily basis to match the change of Grid-Point IRS template on a daily basis. By this method and system, the present investment instruments and positions in them may always be priced directly off spot UDP quotes, which is a significant improvement in transparency over the conventional IRS system. Also, activity both within sessions and across sessions is fungible at the instrument/position level, which is significantly more efficient than the conventional IRS systems.

Investment instruments which are structured so as to possess break-even ELᵢ within the instrument are distinguished from those for which the break-even EhLᵢ is more readily associated with a position in the instrument. The distinction is largely one of convenience, and is driven by a desire to simplify expressions for break-even dynamics by excluding non-inventive contributions, which typically relate to the parallel cash account which accompanies trading in present instruments.

Adjustment IDAᵢ has at its core an index-driven component. Full expressions are given in Appendix 01B. Concentrating on the index-driven element, this is present in the present products to account for the carry that would otherwise be associated with rolling from one daily Grid-Point IRS template to the next.

The carry can be quantified as the premium of the break-even fixed rate for a one-business-day spot-starting arrears set/arrears paid CMS trade over its closing UDP rate input. As taught in application Ser. No. 11/387,974, entitled “Methods and Systems for Commoditizing Interest Rate Swap Risk Transfers”, dated 24 Mar. 2006, it can be expressed in this capitalised form as SNIP_{i,K}, and it is akin to the cash dividend on a stock. It may also be expressed as an equivalent rate SNIPR_{i,K}, which is akin to a dividend yield, and like SNIP_{i,K} is applied to the cash account.

### Redenomination

Present investment instruments are denominated in units of PV01. For example, in system 200. This mirrors the use by the UDP commodity of PV01 as its unit of denomination. PV01 is also expected to be the dominant measure of size for trading purposes.

This is stated rather formally so as to distinguish the contractual nature of the PV01 scaling in present investment instruments from a transactional use in standard IRS trading. Specifically, conventional IRS trading has been conducted in terms of PV01; however, the executed PV01 does not feature in the ticket or contract, where it is replaced by an equivalent notional amount. The conversion between notional amounts and PV01 has been conducted according to widely agreed protocols and methods. By using the known protocols and methods in reverse, present investment instrument trading can be conducted in terms of notional amount. This notional amount is then converted into its equivalent PV01 for inclusion in the ticket or contract.

### Price

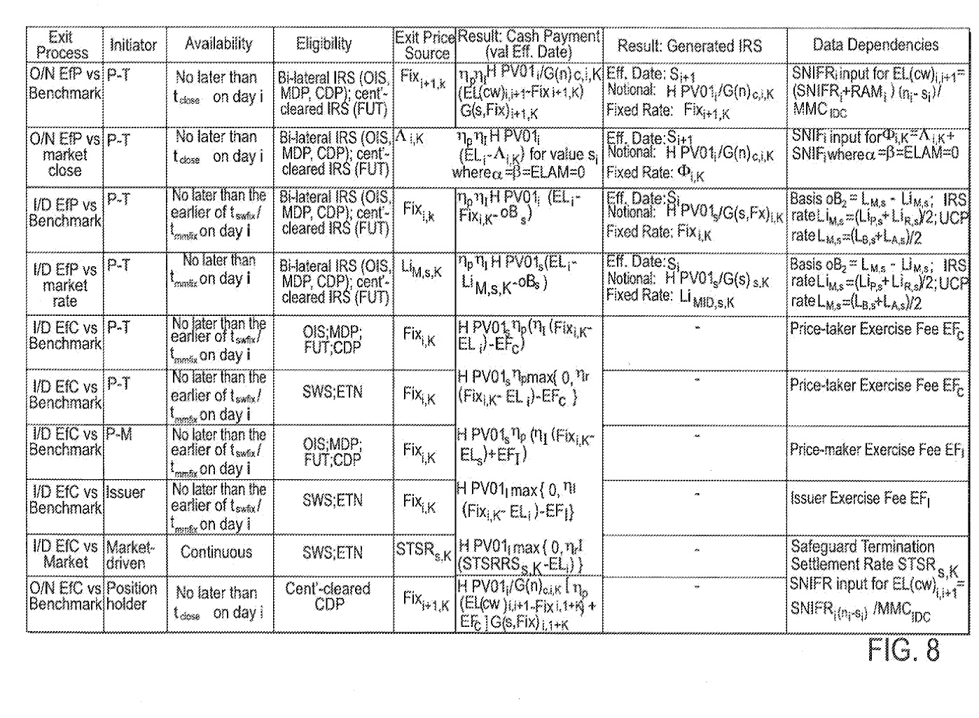

FIG. 8 illustrates tabulated primary exit processes from present investment instruments into cash payments, into alternative present investment instruments and into Generated IRS. The simple, direct, arithmetic formulation which relates live UDP quotes L_{q,K} into instrument prices P_{q} is an element of the present invention. The formulations for individual embodiments is tabulated in FIG. 8. The strong link between intrinsic worth V_{q} and secondary price P_{q} is enforced through the daily primary exit routes of the present system.

### Digitization of Time

The time dimension of the inventive digitisation process involves digitizing time into units of one-business-day, according to one embodiment. One-business-day slices are chosen so as to match the pace of Grid-Point IRS template change. This match-up has a number of benefits, predominantly derived from the spot rate tracking it enables, and requires certain complications to be handled in order to operate effectively.

In describing the present system, the terms “day” and “period” to encapsulate one cycle. Terms are chosen to aid common sense understanding, given that the inventive cycle does not always coincide with a calendar day, and to account for the presence of weekends. There are several important events in the daily cycle, and their relative configuration is specific to each UDP.

Opening Time tₒₚₑₙ is defined as the first time at which trading in period i/on day fₛᵢ occurs. Values may be prepared in advance for use at this time, for example to seed an intra-day process; values may be recorded at this time based on market observation.

Short-Rate Fixing Time t_{mmfix} is defined as the time at which the rate fixings for the floating leg of the Grid-Point IRS are calculated. There may be a lag between calculation and publication. Prior to this time, live Fixing Basis FB_{q,K} is equal to zero.

Swap Benchmark Fixing Time t_{swfix} is defined as the time at which widely-adopted rate fixings for Grid-Point IRS are calculated. There may be a lag between calculation and publication. Where there is more than one fixing, from competing data providers or at different times, there may be multiple Swap Benchmark Fixing times per daily cycle, in which case references will be to the most convenient fixing given the context.

Closing Time t_{close}, also known as UDPI Fixing Time, is defined as the last time at which trading in period i/on day tₛᵢ occurs. Market data may be sampled at this time, for example to provide inputs to end-of-day processes; committed UDPI values are typically calculated at this time with reference to these data samples. There may be a lag in the present system between calculation and publication.

The terms “yesterday”, “today” and “tomorrow” are used to aid common sense understanding, while noting that their use within the iterative daily framework may introduce technical ambiguity. See Notation section.

Also, given that certain Financial products will be traded OTC, certain conventions which may develop around this daily cycle are not meant to be excluded. One such example may be the use of Closing Time on day i to signal a switch prior to Opening time on day i+1 to trading for value sᵢ₊₁ using sensitivity factor SFᵢ₊₁ which has yet to be calculated and published and therefore requires deferred ticketing. See Appendix 01B.

### Index-Driven Adjustment IDAᵢ: Dynamic PV01 (UDPI: SNIPn_{i,K})

For SNIPnᵢ-driven instruments, and positions in them, the return associated with the UDP risk is applied as a change in PV01. This may occur within instruments, as a change to their unit sensitivity Sᵢ while leaving executed unit number Nₛ unchanged, or as an adjustment to the balance of the PV01 account (which effectively leaves unit sensitivity S unchanged while adjusting unit number Nᵢ). Formulations are given in Appendix 01B.

Since UDP-based performance is applied in units of itself, there is no need to detail the dynamics in any associated cash accounts.

### Index-Driven Adjustment IDAᵢ: Maintenance Charges

Price-makers, Issuers, Account Providers & DV01 Deposit-Takers may apply maintenance charges to the present investment instruments and positions in them. These will vary according to instrument and context, but certain generalisations are possible. Margins will typically be configured to generate revenue for suppliers to cover instrument maintenance and support services.

Entry Level Adjustment Margin ELAM, which can be expressed as a fixed periodic amount or in alternative embodiments could be expressed as a rate, is a general fee applied to Entry Level Adjustment ELAᵢ.

Deposit rate Dᵢ may bear a number of margins. Margin DMᵢ may operate over launch proceeds; margin MMᵢ may operate on implicit mark-to-market balances (MMLM/MMBM); margin SCMᵢ may operate on synthetic cash balances (SCLM/SCBM); margin CMᵢ may operate on general cash balances in parallel cash and variation margin accounts (CLM/CBM).

Margin INMᵢ may be applied to a SNIPnᵢ rate for period i. This margin may take one negative value INLM for (Price-taker) long UDP balances and a second positive value INBM for (Price-taker) short balances.

### UDPI Components

UDPIs account for the change in reference frame for the UDP commodity relative to the underlying Grid-Point IRS. An expression for SNIP_{i,K} is presented in Appendix 02. SNIPR_{i,K} may then be expressed in terms of SNIP_{i,K}, and finally SNIPn_{i,K} in terms of both SNIP_{i,K} and SNIPR_{i,4K}. Appendix 03 provides expressions for the components (up to three) of SNIP_{i,K}.

First, the Forward Swap Premium SNIF_{i,K} is calculated, which accounts for the template shift for Grid-Point IRS traded on day fₙᵢ=f_{s,i+1} versus those traded on day fₛᵢ. The expected rate Φ_{i,K} for the (forward-starting) Grid-Point IRS with effective date nᵢ must be calculated at the close on day fₛᵢ. It can then be expressed as a premium (which can be negative) over the short-rate-fixing-adjusted input rate Λ_{i,K}.

Second, Convexity Correction CCᵢ is calculated, which accounts for the mismatch between the natural payment basis on the Grid-Point IRS relative to the promised spot payments under the present instruments.

Third, Quanto Correction QCᵢ is calculated, which accounts for cases in which IDC is not the same as GIDC. For instruments reliant on these indices, the participant has protection against adverse FX rate movements, specifically the weakening of GIDC 50 relative to IDC. The value of this benefit is charged back to the index by way of the third term in the expression for SNIPᵢ.

In all cases, it is possible to calculate projected values pSNIP_{i,K} (+components) in real time ahead of committed values cSNIP_{i,K} by substituting live market levels for committed closing market levels. These projected values have a number of uses.

Market participants adopting the UDPIs for inclusion as value drivers within financial contracts will bear risk against their fixings. The following outlines the scale of this risk.

Within the definitions provided by ISDA®, percentage figures are, unless otherwise specified, to be rounded to the nearest one hundred thousandth of a percentage point (9.876541% is rounded to 9.87654% and 9.876545% is rounded to 9.87655%). Agreement on UDPI values to one ten millionth of a percentage point can be reached off pre-agreed input data and methods. Agreement at an order of magnitude of hundred thousandths of a percentage point, the maximum accuracy prescribed by ISDA® for governing contractual payments, is likely across the family of (production) systems in commercial operation. Agreement at this order is not necessary for the validity of the present invention.

Observe that current output values (USD & EUR) of CCᵢ are 0.00001%-0.00020% and those of QCᵢ are less than 0.00010%; these values are small relative to bid/offer spreads in the IRS market, and the risks associated with the value of these elements can be managed in the general course of an IRD trading activity. Their small scale, allied with their intra-day stability, means that in practice Dealers may be willing to assume them without explicit daily notification.

### UDPI: Conceptual Framework

Consider a conventional floating rate note (“FRN”). The return on the FRN is governed by the periodic fixing of a benchmark rate. This benchmark rate has a special property. Ignoring credit risk, at each fixing date the future payments under the FRN have a present value of 100% of Par. Put in marginal terms, benchmark-rate-based returns compensate the holder of a financial instrument exactly for delaying their return of face value. Expressed more technically, the value of the benchmark return is equal and opposite to the value of the capital deferral, or NPV (capital deferral plus benchmark return)=0. This property has many uses. For example, practitioners use it to derive grid-point swap curve discount factors as outlined below, where the benchmark rate is LIBOR in the case of US Dollars and is EURIBOR in the case of euros. It also means that there is no contribution to net present value from future periods where capital deferrals are compensated by benchmark-rate-based income.

In the present system, face value is the intrinsic worth of an instrument (see FIG. 3C). Holders have the opportunity to buy and sell the instruments continuously on a secondary basis; they also have daily opportunities for primary exit. Should a position be held overnight, participants earn the fair value for that overnight position, and experience it through adjustment of PV01ᵢ and/or ELᵢ/EhLᵢ. UDPIs are the market benchmark rates governing that process.

Where margins are imposed, such as INM/RAM/ELAM, this validity of this concept may be threatened on a purely theoretical basis, but provided the magnitude of the margins is kept small relative to bid/offer dealing spreads, the method and systems remains valid from a practical perspective. In the present system, the issue can be dealt with by adopting suitable accounting methods for the products, for example on an accruals basis.

### UDPI: Input Data & Processing

In the present method and system, Λ_{i,K} is distinguish as a special case of L_{c,K}, which is itself a timed sample of live quote L_{q,K}.

There is flexibility over the choice of data sources, the application of filtering processes & integrity checks and the specification of averaging procedures used in respect of raw data. Indeed, in one optional embodiment, committed index component values could be produced by arranging receipt of individual Dealer-calculated index component values, such as SNIPᵢ, as pre-configured dealer data and then averaging these values directly.

According to one embodiment, it will be possible to work with individual banks in producing distinct indices to support the launch of products in which only that one bank makes an active market. The role of the Index Calculator as an independent index provider may still prove critical in terms of client credibility. This possibility might result from the desire of only one Dealer to have indices in a particular emerging currency, for example. In such an embodiment, it is likely that 3^{rd} party data would be necessary as an input to the index calculation process, but embodiments are possible in which the only inputs to the calculation process are those sourced from the single instrument Dealer.

However, the set of necessary output data and the timing cycle for deployment are important elements which are specific to the present method and system, and allow the method and system to operate correctly and link into conventional channels to enhance their usefulness. As a result, the credibility gain from using an existing benchmark such as the ISDAFIX® swap rate fixings must be balanced against the loss of mechanical accuracy from introducing any timing mismatch.

Once produced, committed UDPI values may be transmitted to market participants, following one of any number of non-proprietary distribution models for market data.

### Exchangeability Between Product Embodiments (“EfF”)

Positions in a first instrument may be exchanged for positions in a second instrument, provided the UDP exposures are economically equivalent and subject to managing the additional risks (credit, operational, legal, regulatory). These instruments may be of the same embodiment, or may be from distinct embodiments. EfE here extends beyond that available through open secondary market activity, and commercial terms may be written into instrument specifications or into customer/supplier agreements.

An example would be the ability on the contract expiry date to convert an open position in a UDP-based futures contract into an open position in an ETN. See Appendix 04A. By this method, liquidity of the instruments is improved, and may solve otherwise intractable problems of physical IRS delivery. The methods may be implemented bi-laterally or through anonymous auction processes, for example in system 200.

### Exchangeability for Physical Grid-Point IRS (“EfP”)

The ability to convert UDP risk into Grid-Point IRS risk is important for the effectiveness of the present fanancial products. Without the convertibility, the basis between live UDP quotes L_{q,K} and Grid-Point IRS quotes Li_{q,K} would be more labile, and the reliability of present products would be reduced.

The theoretical mechanism for translating UDP risk into Grid-Point IRS risk has a number of practical applications, not least in enabling early termination features within present financial products. These features may be voluntary or mandatory; where voluntary they may be activated by customer or by supplier; and they may be once daily or in some cases continuous. They represent a delta-preserving alternative to secondary instrument exit routes.

Key factors handled by individual mechanisms are (i) the denomination change; (ii) the IRS/UDP basis; and (iii) any timing mismatch between decision and execution.

In the presence of margins, the number of practical routes is enlarged. In the absence of margins, to avoid arbitrage, the denomination change must be synchronous with elimination of the basis. According to one embodiment, the convergence of CB_{q,K} to zero at the close is taken advantage of. This time, and rates prevailing at this time, is chosen to translate denomination from PV01 to Notional Amount. In doing so, the need to adjust for convexity is removed, but incorporates the need to handle the short-rate fixing. In this event, the Generated IRS has effective date sᵢ₊₁, a date schedule driven by sᵢ₊₁, and notional amount N(IRS)_{s,i,i+1} calculated from G(n)_{c,i}. Its fixed rate may be set with reference to a benchmark fixing rate Fixᵢ₊₁ published the next day, or it may be set with reference to closing rate Λᵢ. In both cases, a cash payment is due. See Appendix 04.

It is assumed in the above that exchange would be activated by the original Price-taker. For these participants, for open positions in instruments where η_{I} was set at execution, η_{P}=1. Price-takers preserve the Sense of their position. In Appendix 04, cash payments are expressed from the Price-taker's perspective, such that a negative payment should be interpreted as a receipt by the Price-taker on exchange.

### Immediate Cash Settlement of Physical Grid-Point IRS

There are constraints to engagement in conventional IRS. To enhance further the usefulness of the present financial products, a method and system by which EfP described above is followed immediately and automatically by cash settlement. By doing so, the Grid-Point IRS output of the EfP process is a transient and notional state, and its operational consequences (e.g. credit line requirement) are eliminated.

Cash settlement exit routes extinguish delta risk. As a result, a margin will typically be applied to the exit rate to account for the risk transfer. This will generally be a charge to the party activating the process, or to the instrument holder where market-driven. Price-markers and/or account providers for the instruments may be required to participate in schemes facilitating this (and their EfP pre-cursors).

These margins EF are expected to be of the order of tenths of basis points. This will typically mean EF>>B_{q,K}, which in practice removes an arbitrage opportunity for UDP receivers who might otherwise attempt to extract the CB_{q,K} premium.

To make it explicit, the combinations of EfP followed by immediate cash settlement are direct and transparent routes for liquidating UDP risk positions which need not rely on an individual Price-maker's secondary quote. See Appendix 05 for pay-off formulations.

### Instrument Lending

Where product embodiments are strict assets (CDP, ETN), it will be necessary to facilitate short positions (ηₚ_{_{—}}rt_{o,i}=−1). This will allow participants to create a UDP Sense (ηₚ_{_{—}}rt_{o,i} η_{I}) which reverses instrument Sense η_{I}. Short positions will rely on repo markets. An expression for theoretical real-time spot/next repo rate SLR_{q} is provided in Appendix 07. Note that the market repo rate may deviate from this.

### Product Accounting

The fungibility of positions in present investment instruments has a positive impact when accounting for multiple transactions over a period of days. See Appendix 06 for expressions relating to instruments with static PV01 (SNIP- & SNIPR-driven). These include potential margin management.

For contributions to running total values from individual transactions executed in period i, see Appendix 06. Replacing live rate(s) L_{q} with closing rate(s) Λ_{c,i} in the formulations for VM_tc_{q}, UPL_tc_{q} & AssV_{q} gives closing contributions. Note that running totals of initial margin, realised P&L and unrealized P&L may not be purely additive, and will account for the interplay between individual (offsetting) trades.

### Primary Phase

For the purpose of this application, primary processes may be defined as those which support the issuance and redemption of present investment instruments. They are distinct from secondary trading, which transfer instruments between holders without changing the commercial terms of the instrument itself. Under this definition, conventional IRS trading is a primary activity. New instruments result from executing generic daily activity, with their individual commercial terms written into freshly produced contracts. This is one reason why activity is expensive. In contrast, present investment instruments simply change hands.

The specifications of each investment instrument are set in the primary phase, and are then loaded into electronic trading platforms. According to one embodiment, present investment instruments are loaded on OTC exchange server 210 described in FIG. 1C. This process may include establishing agreed support services, such as analytical functions or ticket processing linkages. Instruments are then made available for trading among market participants, who simply require access to settlement facilities for the clearing system in question.

### Secondary Market Quotation

It is a peculiarity of conventional IRS that participants may only exit a position either by buying out the original position or by executing a new offsetting position. The former is strictly secondary activity, but in an instrument which is sufficiently non-standard to all but its original parties that the workload is equivalent to that for primary. The latter causes unnecessary portfolio growth, with its attendant costs.

FIG. 8 illustrates tabulated primary exit processes from present investment instruments into cash payments, into alternative present investment instruments and into Generated IRS. The present investment instruments will have secondary markets as the main entry and exit routes for participants. Electronic trading platforms may employ streamed quotes or an RfQ process. The valuation function connecting asset values AssV_{q} with UDP quotes L_{q} is tabulated in FIG. 8. The Quotation regime is also tabulated, and greater granularity governing the inter-relationship in the presence of a bid/offer spread is provided here.

IRS Pay quote Li_{P,q} always corresponds with UDP bid quote L_{B,q} and IRS Receive quote Li_{R,q} always corresponds with UDP sell quote L_{A,q}. For η_{I}=1, bid rate L_{B,q} corresponds with bid price P_{B,q} and L_{A,q} corresponds with P_{A,q}; for η_{I}=1, bid rate L_{B,q} corresponds with offer price P_{A,q} and L_{A,q} corresponds with P_{B,q}.

All investment instruments can be traded off live quote L_{q}. Certain investment instruments may also trade off pre-configured panels displaying prices P_{q}. For instruments for which θ_{AV}=1 (TRI, SWS, CDP, OIS), the price panels could display values P_{q}=AssV_{q}. For iMID Futures, the price panels could display quotes P(Futures)_{q}=η_{I}(L_{q}−EL₁), with EL_{I}=100%/η_{I}=−1 and EL₁=0%/η_{I}=1 as preferred embodiments.

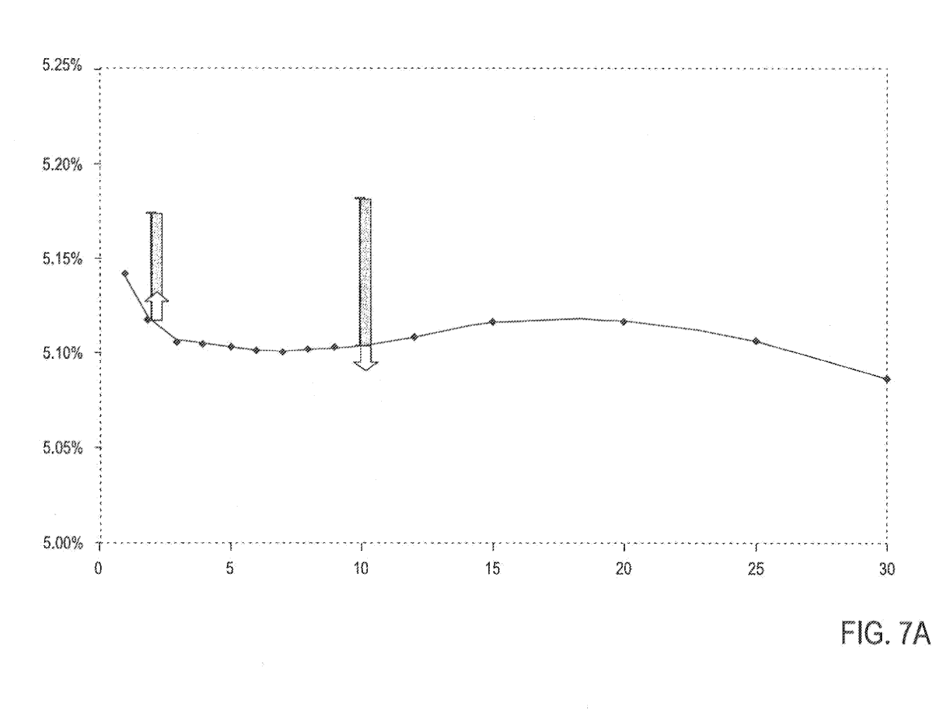

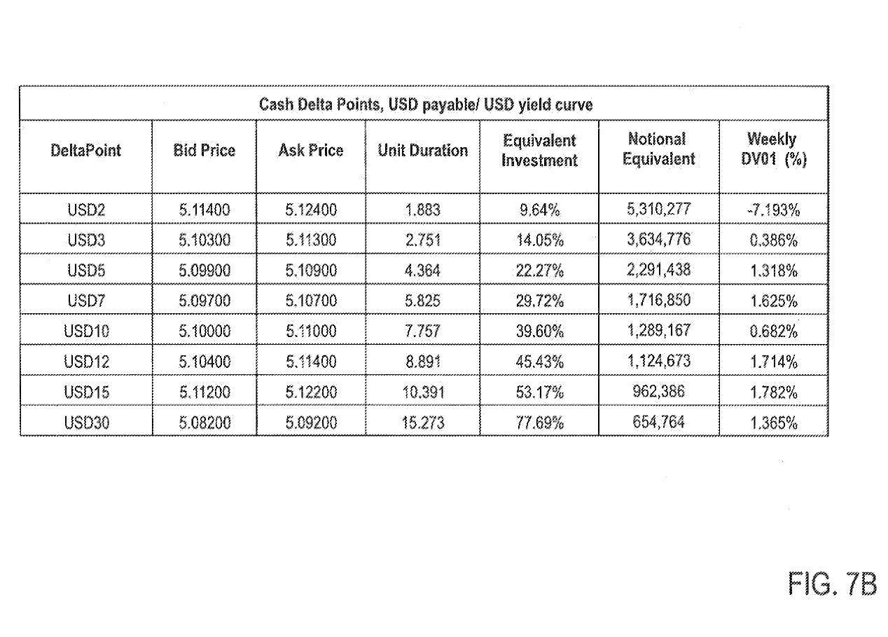

FIG. 7B illustrates an example of price display panel for CDP which participants can view pre-execution CDP instrument data. The DeltaPoint field may adopt the following conventions for a single currency instrument: [GIDC][K], where GIDC is the SWIFT code of the currency, by definition both UDP and payment currency for the Series; and K is the UDP tenor in years. According to one embodiment, a number of other derived instrument characteristics are supplied via real-time processes for display for each instrument.

### Secondary Market Ticketing

Market conventions will have to be established to ensure homogeneity in the manner in which present investment instrument prices are displayed (discussed above), and in the manner in which trading and ticketing is conducted.

Tickets in iMID instruments vary according to product. However, all tickets must convey information in six key areas: an instrument identifier, the trading partners, their respective positions, the size, the execution price, and the trade date and settlement date.

FIG. 3D illustrates tabulated default ticket data by instrument type. According to context, this information may be organized and translated for the purpose of efficient trade capture.

Instrument identifier: This may be a code from an external classification such as ISIN (SWS, ETN, FUT, TRI), an internal reference of a counterparty (OIS, TRI), or a direct UDP reference UDPₛ (MDP, CDP, OIP, TRI). Use of UDPₛ may incorporate data gathered on the path to execution.

Trading Partners & Buy/Sell: Every transaction involves a Buyer and a Seller; tickets must identify them. In the case of OIP, for which the ticketing burden is greatest, the Price-taker is deemed the Buyer (ηₚ=1), with Sense set according to whether the Price-taker pays (η_{I}=1) or receives (η_{I}=−1); by this regime, Price-makers are sellers (ηₚ=−1) of OIP. Upon instantiation, OIP undergoes an instantaneous transition into OIS, and the buyer may increase (ηₚ=1) or decrease (ηₚ=−1) the instrument size through secondary trading. Save for OIP, buyer and seller may be identified by each party confirming its own position ηₚ and its counterparty C/Pₛ to a (third party) clearing agent. Existing ticket protocols ensure that parties are able to communicate their position unambiguously, and iMID instruments will share these protocols according to product format.

Transaction Timing: Trade date has a default value fₛᵢ and settlement date has a default value sᵢ. There is scope for trading partners to agree alternative dates.

Size: All tickets in present investment instruments have a risk amount PV01ₛ. PV01ₛ is the value at risk under the transaction to a 1 basis point movement in the live UDP quote L_{q}. It will be a figure expressed in units of IDC. PV01ₛ may, for the purpose of quotation and pre-execution analysis, have been converted into (i) a number of instrument units Nₛ; or (ii) a notional equivalent N(IRS)ₛ. The relationship between these variables is as follows:

$$PV {01}_{s} = \frac{{G ( s )}_{s , K} {N ( IRS )}_{s}}{H} ;$$

$${N}_{s} = \frac{PV {01}_{s}}{Sensitivity} ,$$

where Sensitivity is, where variable, that retrieved from the instrument database as applicable for the settlement date in question. Any of PV01ₛ, Nₛ or N(IRS)ₛ may be agreed at dealing. For the purpose of ticketing, we may use PV01ₛ or Nₛ. Nₛ may be referred to as number of units, number of lots or number of securities. Execution based on N(IRS)ₛ must be supported by mutually-accepted protocols governing the source and timing associated with setting G(s)_{s,K}, and for those instruments with a pre-configured Sensitivity, there must be additional protocols to govern the rounding to produce Nₛ.

Price: Each piece of executed business is associated with a UDP rate ExLₛ. ExLₛ is the instantaneous extract from the continuous live quote series at the point of execution. ExLₛ substitutes L_{q} in formulations of NAssV_{q} to give price & value at execution Pₛ & NIAₛ, with ELᵢ=ELₛ, as shown within FIG. 3D. As noted previously, ExLₛ may be expressed or presented in basis points (“450.1”) or as percent (“4.501”) as well as taking its strict value in absolute terms (“4.501%”, “0.04501”). System implementations will adjust for this through the use of scaling factors H (=10,000) and 100 respectively. Conversion of rate ExLₛ into ticket price Pₛ requires there to be mutually-accepted protocols to govern rounding. We may also work backwards from price Pₛ to determine ExLₛ. Price Pₛ will serve one of two functions: it will be the basis from which invoice amounts are calculated for Cash instruments, or it may be the initial reference point for margining for CFD instruments.

See Appendix 08 for a discussion of certain unique ticketing requirements for OIS/OIP.

### Risk Management

The market data variables which drive the dynamics of present instrument value are available, explicitly or implicitly, within conventional IRS markets. This is an advantage. It means that the market risk from dealing in the contractual embodiments of the present invention can be managed by traders within the framework of an existing interest rate risk management business.

The first-order (delta) risk can be offset by trading in conventional IRS. This will leave two second-order risks within the hedged portfolio: Fixing Risk and Convexity Risk. A third Quanto Risk is relevant for instruments for which IDC≠GIDC.

Fixing Risk is defined as the difference between the values pUDPI_{i,K} anticipated by the participant's system relative to the contractually-binding values cUDPI_{i,K} ultimately published by the index calculator.

Fixing Risk is defined as the difference between the values pUDPI_{i,K} anticipated by the participant's system relative to the contractually-binding values cUDPI_{i,K} ultimately published by the index calculator.

Convexity Risk is generated when present instruments (denominated in PV01) are hedged by IRS. For secondary trading, it is handled via adjustment CB_{q,K} to UDP quotes L_{q,K}. Participants may employ option strategies to manage this risk.

There are multiple exemplary embodiments of the graphical participant interface via which these risks can be reported to participants for ongoing management. Risks are split per UDP/Grid-Point IRS pair. Risk managers may elect to view risks from an Intra-day or an Overnight perspective. Their choice will be driven by time of day and rate of position turn-over.

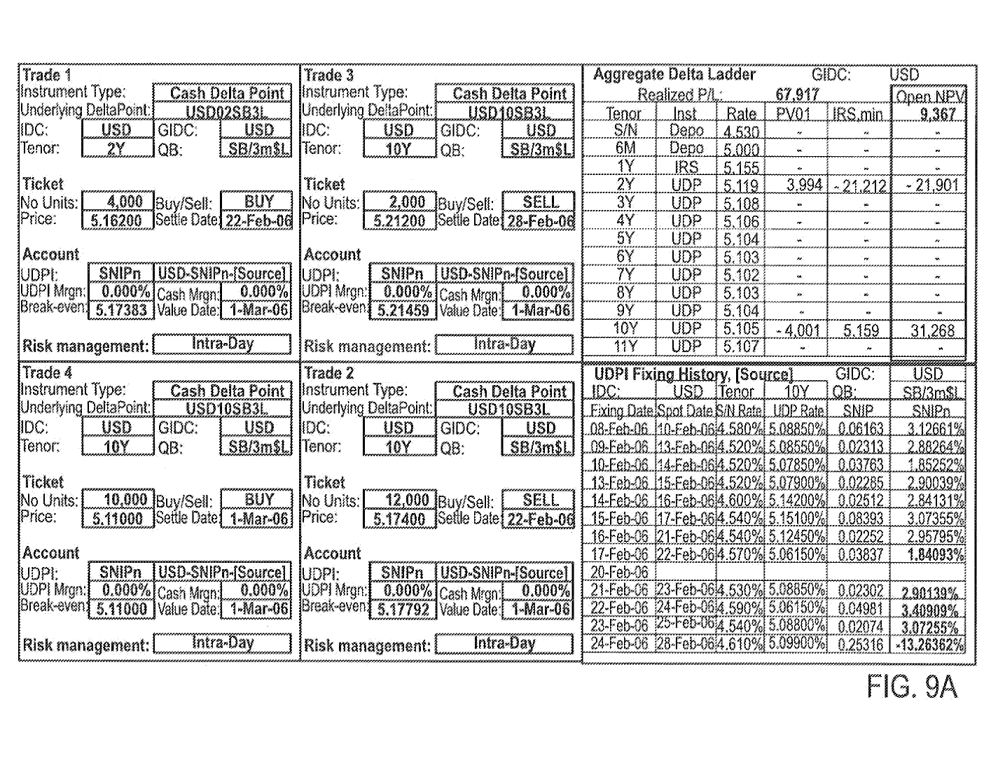

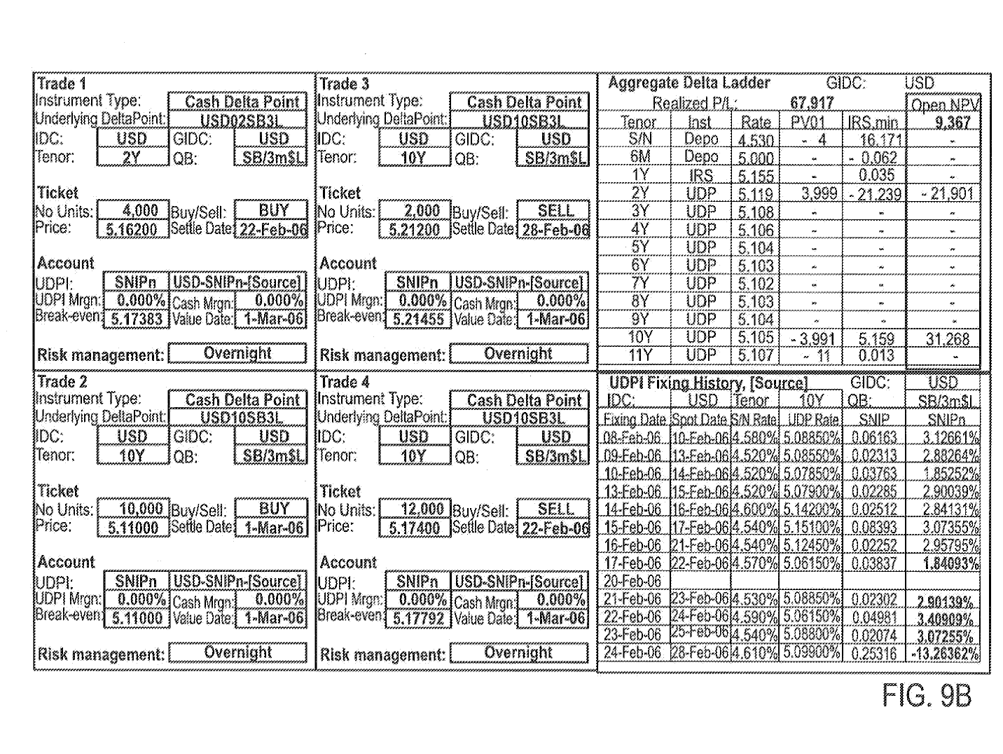

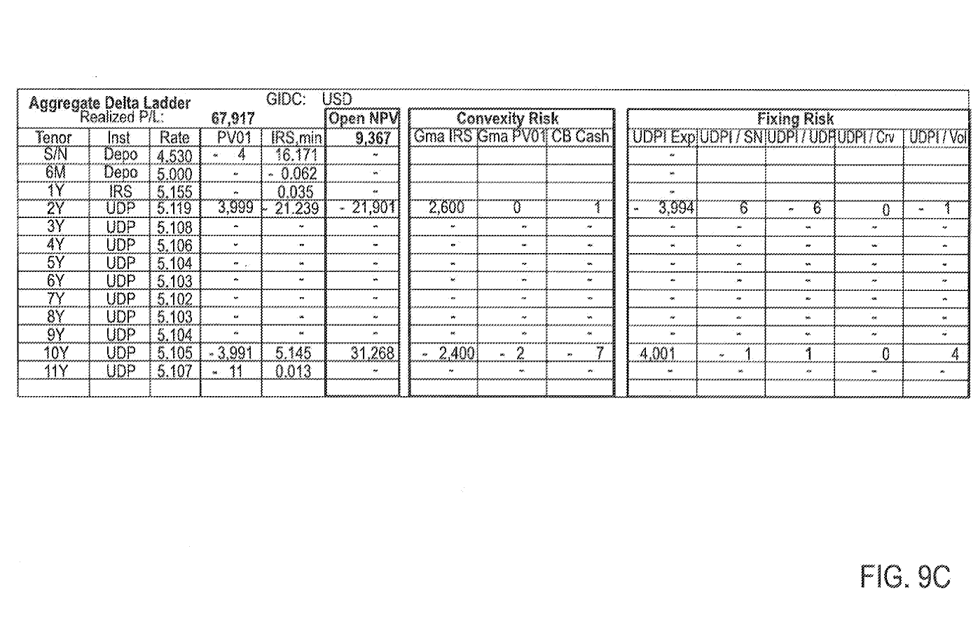

FIG. 9A illustrates an example display configuration for present instrument windows and first order risk report, alongside example index series data, following the position described in FIG. 11C, wherein the risks are reported from an IntraDay perspective. For Intra-day (the default), risks are reported as if present instrument positions will be closed out at or prior to market closing. Present instruments are valued as if both legs in the contract are set and paid early. This eliminates Fixing Risk. The convexity mismatch can be reported via GmaIRS, GmaPV01 and CBCash. UDPIExp, SNIPRExp, SNIPnExp & IdxExpo can also be reported.

FIG. 9B illustrates an example display configuration for present instrument windows and first order risk report, alongside example index series data, following the position described in FIG. 11C, wherein the risks are reported from an Overnight perspective. For Overnight, risks are reported as if present instrument positions will be held open overnight. Present instruments are valued as if both legs are set and paid one-business-day in arrears. In the absence of margins within IDAᵢ, there is no change to position NPV. Measures of Fixing risk (UDPI/SN, UDPI/CPt, UDPI/Cry & UDPI/Vol) become relevant and are reported. FIG. 9C illustrates the first order risk report displayed in FIG. 9B along with additional second order risk data.

SNIPExp, SNIPRExp and SNIPnExp are defined as aggregate open PV01 exposures referenced against the UDP in question for instruments indexed on SNIP only, SNIPR only and SNIPn only respectively. UDPIExp is the sum of SNIPExp, SNIPRExp and SNIPnExp values.

GmaIRS is the change in IRS Notional Equivalent for a 1 bp upward movement in rates Li_{q,K}, with a positive figure indicating a long gamma position. For present instruments in isolation, as in FIG. 9C, GmaPV01 can be the PV01 equivalent of GmaIRS, being GmaIRS*G(s)_{q,K}. More generally, and for mixed prior art and present instrument positions, GmaPV01 is the change in PV01 of the combined position for a 1 bp increase in rates.

CBCash is the prevailing cash equivalent value of CB_{q,K}. A positive figure indicates embedded long gamma value that will be lost into the next UDPI Fixing Time. Looking forward from the next UDPI Fixing Time, CBCash will equal H PV01_{K} CC_{i,K}. This could also be reported as Decay, the negative of CBCash, being expected time decay.

The subsequent figures are sensitivities of the position, via UDPIExp and expressed as cash value, which result from potential discrepancies between a participant's input values and those market averages which are implicit within the published UDPI figure.

UDPI/SN is the sensitivity of the UDPI position to a 1 bp increase in the S/N rate in isolation. A positive figure indicates a profit to the position in this event. Higher S/N rates increase SNIPn_{i,K}.

UDPI/UDP is the sensitivity of the UDPI position to a 1 bp increase in both the UDP rate and the immediately longer UDP rate. A positive figure indicates a profit to the position in this event. Higher UDP rates reduce SNIPn_{i,K}.

Hedging tools will emerge with increased adoption of these indices. For example, an overnight index swap (“OIS”) is an instrument in which a daily compounded overnight interest rate such as EONIA is exchanged for a fixed payment. A novel OIS in which the SNIPR index replaces the EONIA index is a hedging tool for dealers who find that, as a result of imbalances in their client flows in present indexed products, they experience potentially long-term (1 week or more) SNIPR-index exposure.

As for other index-linked transactions, the notional amounts for these swaps will be the product of risk amount PV01ₛ and H. For a single Calculation Period SNIPr-OIS running from effective date s₁ to termination date n_{T}, we define the single floating rate payment according to the following formulation:

$$Floating Payment = {\sum }_{t = 1}^{T} [ \begin{matrix}\frac{( {SNIPR}_{t} + {RAM}_{t} ) ( {n}_{t} - {s}_{t} )}{{MMC}_{IDC}} {\prod }_{u = t + 1}^{T} \\ \{ 1 + \frac{( {D}_{u} ) ( {n}_{u} - {s}_{u} )}{{MMC}_{IDC}} \}\end{matrix} ] ,$$

where T is the number of business days in the Calculation Period from and including the Effective Date up to but excluding the Termination Date, t is a series of whole numbers running from one to T, SNIPRₜ for any day t is a reference rate equal to the overnight rate as published by the Index Calculation Agent in respect of that day, and RAMₜ is a margin applicable to the reference rate set equal to zero for generic market quotation.

The fixed rate FXD can be quoted and be payable according to standard methods and schemes within the Interest Rate derivatives markets. For a fixed rate quoted on a money market basis, the net payment for value n_{T} would be:

$$( FXD \frac{( {n}_{T} - {s}_{1} )}{{MMC}_{IDC}} - Floating Payment ) PV {01}_{s} H$$

A second novel OIS in which the SNIPn index replaces the EONIA index is a hedging tool for dealers who find that, as a result of imbalances in their client flows in present indexed products, they experience potentially long-term (1 week or more) SNIPn-index exposure.

The notional amounts for these swaps will be the product of risk amount PV01ₛ and H. For a single Calculation Period SNIPn-OIS running from effective date s₁ to termination date n_{T}, we define the single floating rate payment, to be applied to the instrument balance for value n_{T}, according to the following formulation:

$$Floating Rate = [ {\prod }_{t = 1}^{T} \{ 1 + \frac{( \begin{matrix}{SNIPn}_{t} + \\ {INM}_{t}\end{matrix} ) ( {n}_{t} - {s}_{t} )}{{MMC}_{IDC}} \} - 1 ] \frac{{MMC}_{IDC}}{( {n}_{T} - {s}_{1} )}$$

where T is the number of business days in the Calculation Period from and including the Effective Date up to but excluding the Termination Date, t is a series of whole numbers running from one to T, SNIPnₜ for any day t is a reference rate equal to the spot/next rate as published by the Index Calculation Agent in respect of that day, and INMₜ is a margin applicable to the reference rate set equal to zero for generic market quotation.

The fixed rate FXD can be quoted and be payable according to standard methods and schemes within the IRD markets. For a fixed rate quoted on a money market basis, the net payment, to be applied to the instrument balance for value n_{T}, would be:

$$( FXD - Floating Rate ) \frac{( {n}_{T} - {s}_{1} )}{{MMC}_{IDC}} PV {01}_{s} H$$

For both SNIPR- and SNIPn-OIS, the fixed rate for differing maturities for each UDP would be set by the market. These fixed rates are examples of a basis for UDP financing rates for maturities other than Spot/Next. When longer-term financing is applied to individual positions in present instruments, the transparency of the linkage between position value and live quote L_{q} is lost. However, as familiarity with the present instruments grows, we expect markets in term financing of positions to grow.

### Example 1

The manager of a fixed income credit portfolio who is unable to execute conventional IRS wants to buy [symbol] N(N−1) of an 10 yr fixed rate new issue with duration G(N−I)_{q} at its prevailing spread to the mid-swap rate L_{q,10}. The manager is restricted over the scale of the absolute interest rate risk position allowed. The manager would immediately have to reduce their holding of some other credit bond(s) in order to accommodate the new issue, or would have to short-sell [symbol] N(N−I) G(N−I)_{q}/G(G)_{q} of a Government bond with duration G(G)_{q} to offset the rate risk. This exposes the manager to basis risk between the chosen Government bond and the swap rate L_{q,10}, and exposes the manager to repo rate risk in that Government bond.

New alternative using Embodiment A—the manager can buy the new issue and can simultaneously buy PV01 [symbol] N(N−I) G(N−I)_{q} of the Cash Delta Point referenced to L(10)_{q}. This combination locks in the spread to mid-swaps at which the new issue is executed. The interest rate risk profile of the long CDP position offsets the profile of the long new issue position, with an added advantage of a long convexity profile (paid for via the Balance Adjustments). The cash required to buy the CDP position may borrowed from the account provider against its value. With the credit spread managed in this way, the manager is then free to dispose of other holdings at a time of its choosing.

### Example 2

The manager of a $ N(P) fixed income portfolio wishes to lengthen the duration of their interest rate exposure from its current 5 yrs (duration G(5)_{q}) to 30 yrs (G(30)_{q}) without disrupting portfolio credit composition or increasing the absolute sensitivity of the portfolio to a parallel yield curve move. Where the manager is able to execute IRS, they could enter into two IRS transactions, paying fixed on $ N(P) notional of 5 yr IRS and receiving fixed on N(P) G(5)_{q}/G(30)_{q} notional of 30 yr IRS. An immediate short-rate fixing will require hedging via STIR futures. Movements in absolute rates and the passage of time, which will alter the delta sensitivity of each swap, also mean the manager will have to monitor and adjust the relative swap sizes in order to maintain the original neutrality. Upon exit, the manager will receive an amount equal to the net of the two swap unwind values, which will not compare readily to the individual exit rate quotes or to the lifetime spread change.

New alternative using Embodiment C—the manager enters into PV01 $ N(P) G(5)_{q} of an auto-extendible OIS, receiving a fixed rate equal to the spot spread {L(30)_{q}−L(5)_{q}} at execution and paying live spread {L(30)_{q}— L(5)_{q}}. The fixed rate on the OIS adjusts daily according to a net SNIP index contribution (SNIP(30)ᵢ−SNIP(5)ᵢ) and position-wide MAᵢ. Market neutrality is maintained without the need for active management. The manager may exit at their convenience, with an exit pay-out which is transparently linked to individual spot rate quotes L(5)_{q} & L(30)_{q}, and is directly identifiable against a lifetime spread change.

### Example 3

A high frequency credit bond trader creates a closing net interest rate risk as a result of multiple trades across multiple bonds with 4-7 yr maturities. They wish to macro-hedge this risk against overnight rate moves. They evaluate the net risk, select “5 yrs” as the most suitable maturity bucket in which to hedge, and consider their alternatives. They could enter into a generic 5 yr IRS. However, after fresh trading during the next session, the trader finds their risk position reversed and has no further need of the executed IRS. Here, for convenience, the trader does not cancel the original IRS but enters into an offsetting IRS to manage their risk. This trading pattern builds up a portfolio of swap positions which are expensive to maintain but often offsetting in risk. To avoid swaps, the trader could hedge in the most suitable available government bond, or bond future, and dispose easily of the position once it has run its course. This exposes the trader to basis risk between the chosen Government bond and the swap rates against which bond positions are priced, and potentially to repo rate risk in that Government bond (if short).

New alternative using Embodiment B—the trader executes an MDP trade linked to quote L_{q,5} (i.e. the tenor & currency of the IRS into which they would have otherwise entered). The trader agrees ExLₛ and PV01ₛ with the price-maker upon execution. When held overnight, the break-even/holding cost EhLᵢ is adjusted in line with the contractual specification. The following day, the trader reverses the position. The cash exit payment is determined with transparent and direct reference to ExL_{d} and there are no residual open positions.

Other embodiments, extensions, and modifications of the ideas presented above are comprehended and within the reach of one versed in the art upon reviewing the present disclosure. Accordingly, the scope of the present invention in its various aspects should not be limited by the examples and embodiments presented above. The individual aspects of the present invention, and the entirety of the invention should be regarded so as to allow for such design modifications and future developments within the scope of the present disclosure. The present invention is limited only by the claims that follow.

### Appendix 01A

### UDP/IRS Basis

$${L}_{q , K} = {Li}_{q , K} + {FB}_{q , K} + {CB}_{q , K} + {QB}_{q , K}$$

$${FB}_{q , K} = \frac{{V ( FLT )}_{q}}{{G ( s )}_{q , K}} ;$$

$${V ( FLT )}_{q} = ( {FLT}_{qi}^{1} - {FLT}_{Fi}^{1} ) {ω}_{FLT 1} \frac{{χ}_{FLT 1}}{{χ}_{s}}$$

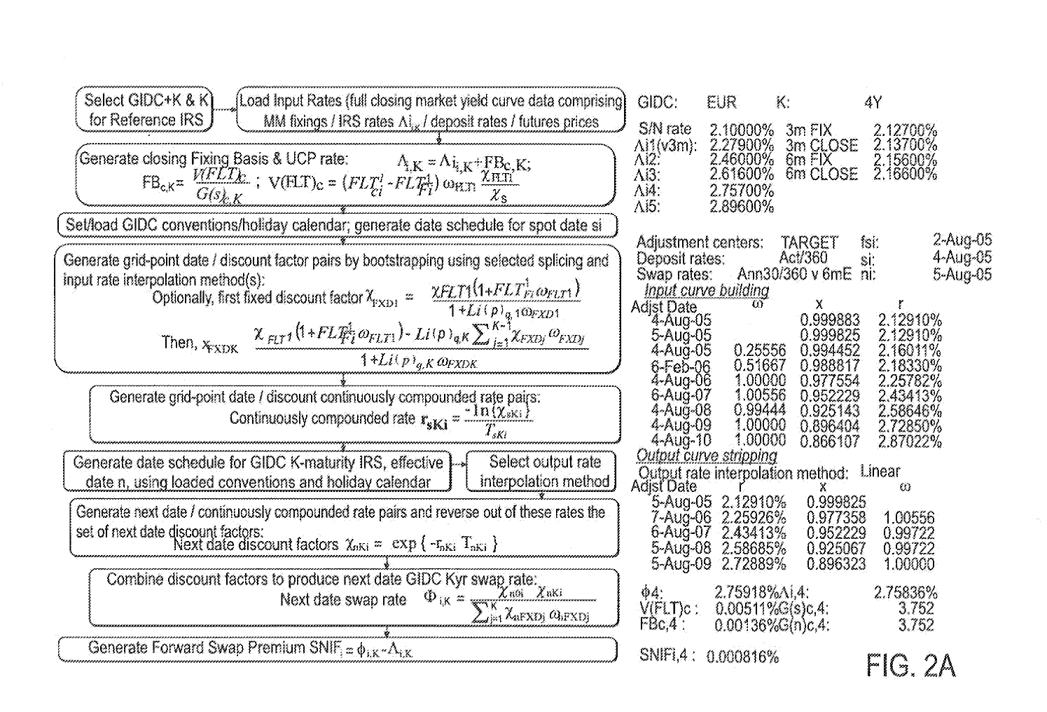

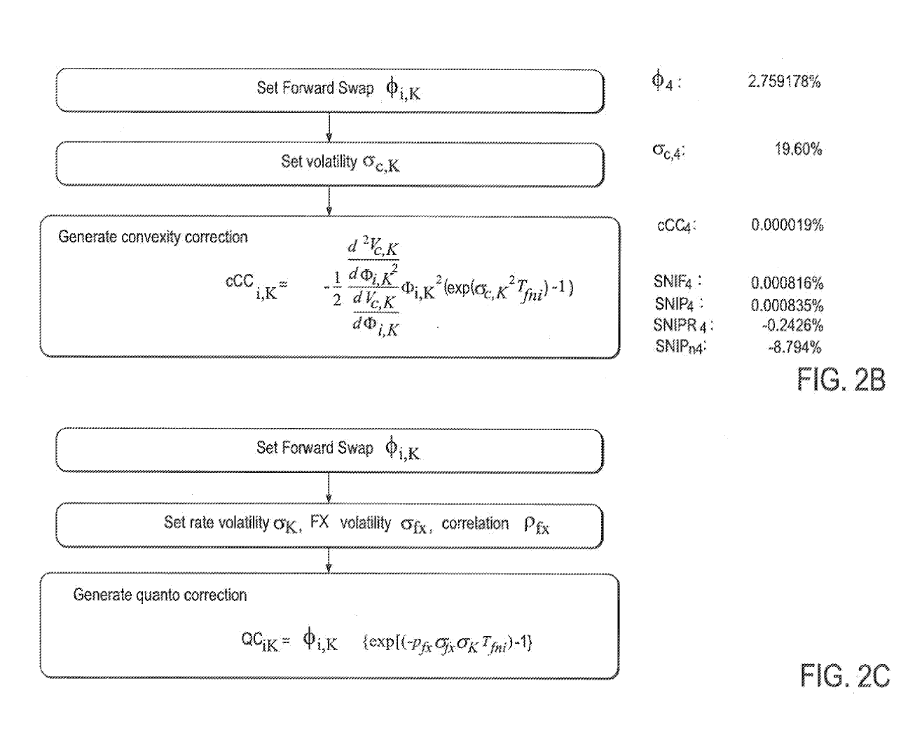

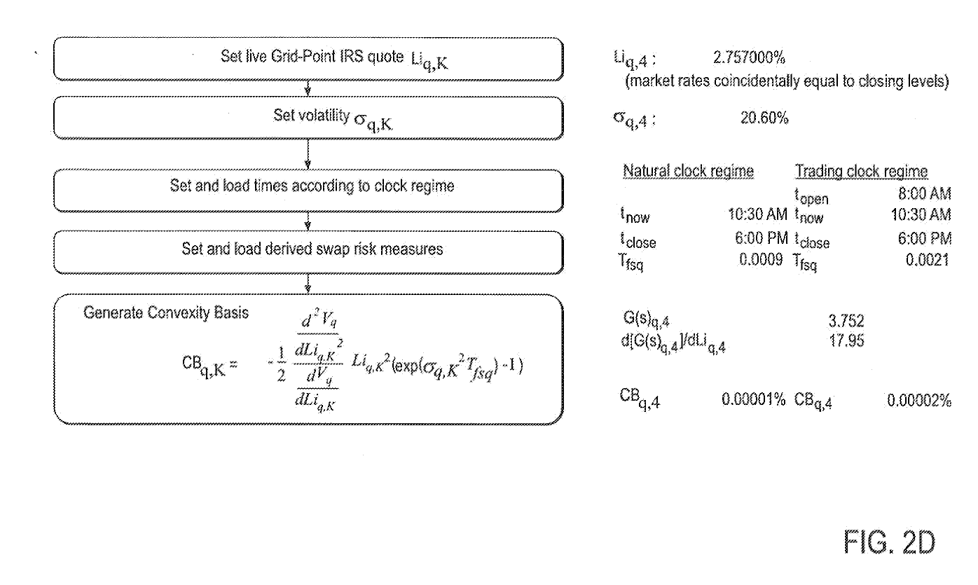

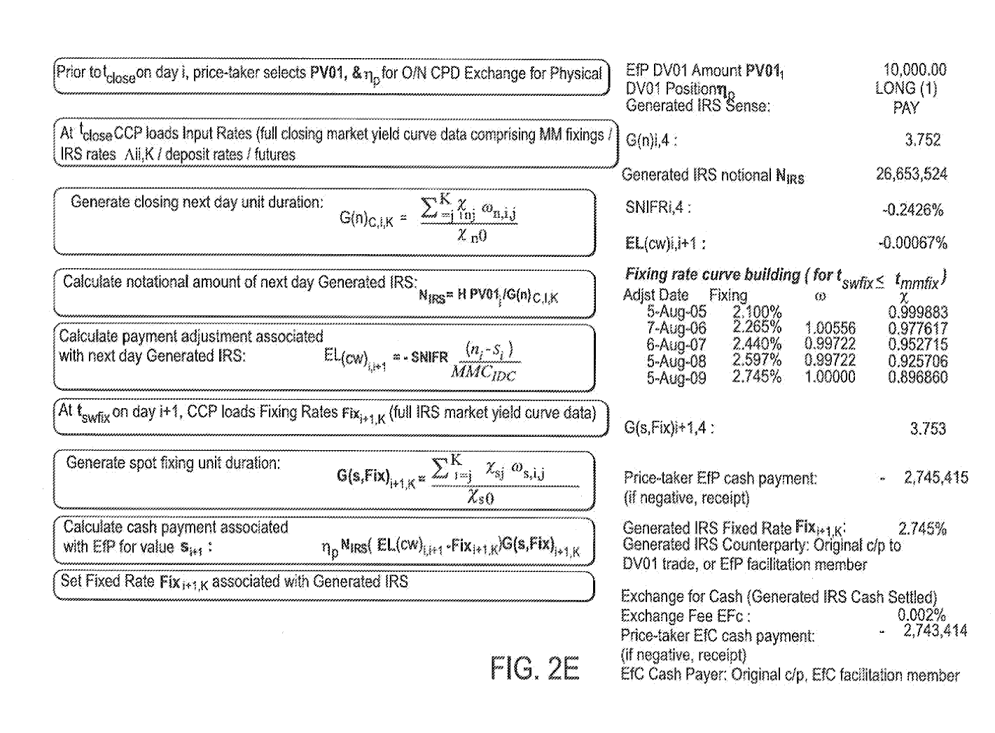

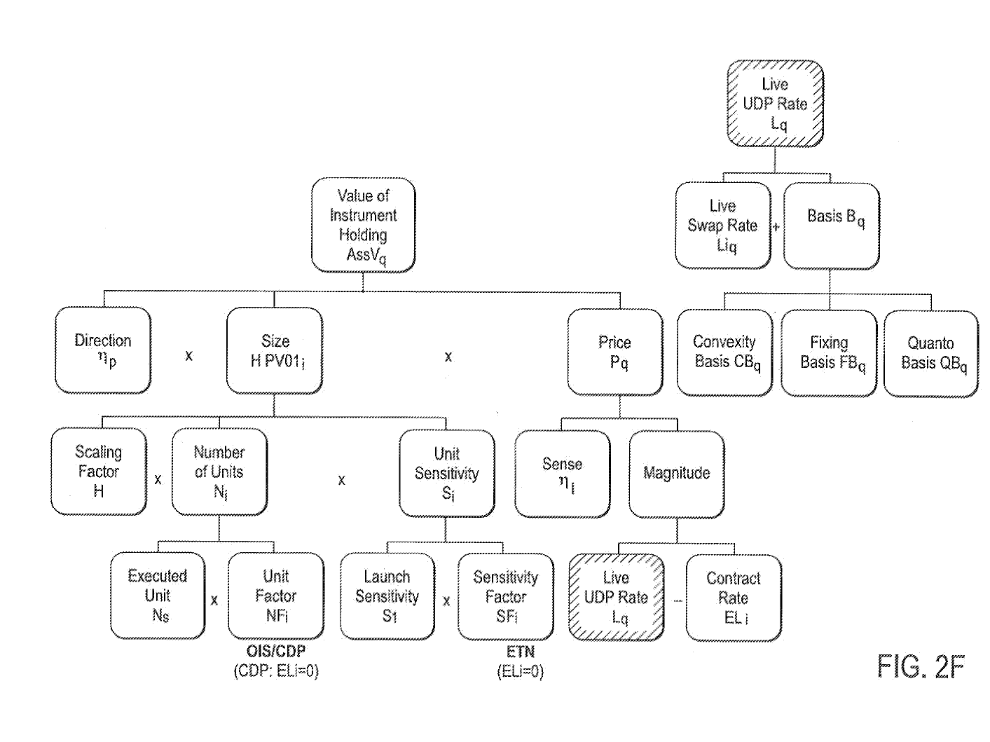

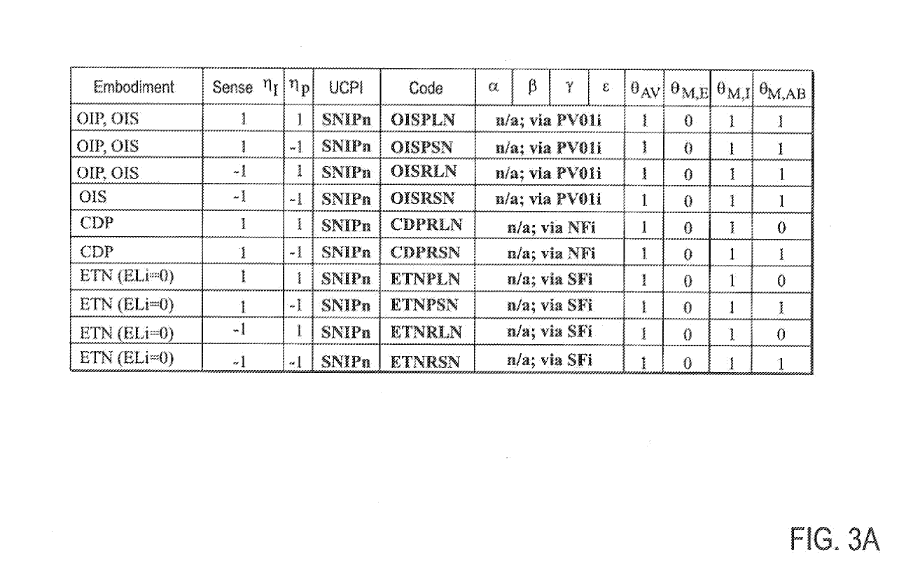

A sample closing calculation is featured in FIG. 2A

$${CB}_{q , K} = - \frac{1}{2} \frac{\frac{{d}^{2} {V}_{q}}{d {Li}_{q , K}^{2}}}{\frac{d {V}_{q}}{d {Li}_{q , K}}} {Li}_{q , K}^{2} ( exp ( {σ}_{q , K}^{2} {T}_{fsq} ) - 1 )$$

Values for the partial derivatives can be generated numerically or by using 3^{rd} party financial analytics libraries. In one optional embodiment,

$$\frac{d {V}_{q}}{d {Li}_{q , K}} = - {G ( s )}_{q , K}$$

$$and$$

$$\frac{{d}^{2} {V}_{q}}{d {Li}_{q , K}^{2}} = \frac{d {G ( s )}_{q , K}}{d {Li}_{q , K}}$$

A sample calculation is featured in FIG. 2D. Typical values have risen sharply in 2008/2009 on heightened market implied volatilities, and have become material in many cases.

QB_{q,K}=Li_{q,K}{exp(−ρ_{q,fx}σ_{q,fx}σ_{q,K}T_{fsq})−1}

### Appendix 01A

### Static PV01 Index-Driven Adjustment Values

IDAᵢ=ELAᵢ+MBAᵢ

ELAᵢ=ε[γ(SNIPᵢ−η_{I}MAᵢ)+(1−γ)(SCIᵢ−RAIᵢ)+η_{I}(αOAᵢ+ELAM−βDAᵢ)]

MBAᵢ=(1−ε)[γ(SNIPᵢ)−(1−γ)RAIᵢ+ηₚη_{I}ELAM]

Self-Contained Instrument Entry Levels:

$${EL}_{i + 1} = {EL}_{i} + {ELA}_{i}$$

$${DA}_{i} = \frac{{C}_{i}}{Senstvty H} {DAF}_{i} ;$$

$${C}_{i} = {C}_{{1}^{*}} {\prod }_{t = 1}^{i - 1} \{ 1 + \frac{( {D}_{t} - {DM}_{t} ) ( {n}_{t} - {s}_{t} )}{{MMC}_{IDC}} \} for i > 1$$

SNIP_{i,K}-Based Instruments:

$${MA}_{i} = [ {η}_{I} ( {Λ}_{i , K} - ( {EL}_{1} + {\sum }_{t = 1}^{i - 1} {ELA}_{t} ) ) - β \frac{{C}_{i}}{Senstivity H} ] {MAF}_{i}$$

Proxy holding cost (externally applied SNIP_{i,K}-based adjustment):

$${EhL}_{i + 1} = {EL}_{i} + {η}_{I} {MBA}_{i} - ( {MFA}_{i} + {CIA}_{i} ) ; {EhL}_{1} = {ExL}_{s}$$

$${MFA}_{i} = {VM}_{i} {MAF}_{i} ( externally \text{-} margined instruments )$$

$${MFA}_{i} = {UPL}_{c , i} {MAF}_{i} ( internally \text{-} margined instruments )$$

$${VM}_{i} = {VM}_{1} + {\sum }_{t = 2}^{i} Δ {VM}_{t} = {η}_{p} {η}_{I} ( {Λ}_{c , i} - {ExL}_{s} )$$

$${VM}_{1} = {η}_{I} {η}_{p} ( {Λ}_{c , i} - {ExL}_{s} ) . \\ Δ {VM}_{i} = {η}_{p} {η}_{I} ( {Λ}_{c , i} - {Λ}_{F , c , i - 1} )$$

$${Λ}_{o , i} ≡ {Λ}_{c , i - 1}$$

$${P}_{F , c , i} = {η}_{I} ( {Λ}_{c , i} - {EL}_{1} )$$

$${UPL}_{c , i} = ( 1 - {θ}_{AV} ) {θ}_{M , I} HVaR {η}_{p} {η}_{I} ( {Λ}_{c , i} - {EL}_{1} )$$

$${CIA}_{i} = [ \begin{matrix}- {η}_{p} {η}_{I} {\sum }_{t = 1}^{i - 1} {SNIP}_{t} - {\sum }_{t = 1}^{i - 1} ELAM + \\ {\sum }_{t = 1}^{i - 1} {MFA}_{t} + {\sum }_{t = 1}^{i - 1} {CIA}_{t}\end{matrix} ] {MAF}_{i} , \\ for i > 1$$

P/L=ηₚ η_{I}(ExL_{d}−EhLᵢ) where ηₚ is the direction of the opening transaction

SNIPR_{i,K}-Based Instruments:

$$\begin{matrix}{SCI}_{i} = ( {EL}_{i} + {η}_{I} β \frac{{C}_{i}}{Sensitvty * H} ) \frac{( {D}_{i} + {SCM}_{i} ) ( {n}_{i} - {s}_{i} )}{{MMC}_{IDC}} & ( 4 R ) \\ {RAI}_{i} = \frac{( {SNIPR}_{i} + {RAM}_{i} ) ( {n}_{i} - {s}_{i} )}{{MMC}_{IDC}} & ( 5 R )\end{matrix}$$

Where SCMᵢ and RAMᵢ are margins applied to Dᵢ and SNIPRᵢ respectively which will be agreed bilaterally between suppliers and their customers in the course of their commercial dealings. For example, margin SCMᵢ could be that employed between a prime broker and a client in respect of a consolidated cash balance in currency IDC. These margins will generally be configured to generate positive value for market-makers.

On a practical level, we expect suppliers to employ RAMᵢ more actively than SCMᵢ to extract value from positions. With respect to accuracy, we observe that short-term deposit rates such as EONIA are quoted to an accuracy of only 2 decimal places in the percent. We expect to produce SNIPRᵢ figures to greater accuracy; we note that the market here signals a high tolerance for rounding with respect to daily compounded rates. We also note that a SNIPᵢ figure rounded and published to the nearest one hundred thousandth of a percentage point corresponds most closely to a SNIPRᵢ figure expressed to the nearest thousandth of a percentage point.

### Appendix 01B

Dynamic Instrument Sensitivity/Static Instrument Number:

$$PV {01}_{s} = PV {01}_{i , s} = {SF}_{i} {SN}_{s}$$

$$PV {01}_{i + 1} = {SF}_{i + 1} {SN}_{s} = ( {SF}_{i} + {SFA}_{i} ) {SN}_{s}$$

$${SF}_{i} = {\prod }_{t = 1}^{i - 1} \{ 1 + \frac{( {SNIPn}_{t} + {INM}_{t} ) ( {n}_{t} - {s}_{t} )}{{MMC}_{IDC}} \} for i > 1 ; {SF}_{1} = 1$$

Where t=1 applies to the Issue Date, i is here the number of business days from and including the Issue Date up to and including the value date, SF₁=1 and INMₜ=a margin applied to the benchmark rate.

Positions for value sᵢ and tickets executed for value sᵢ must use a whole multiple of SFᵢ. This applies for instruments such as ETN (special case SWS).

Static Instrument Sensitivity/Dynamic Instrument Number:

$$PV {01}_{s} = PV {01}_{i , s} = {SN}_{s}$$

$$PV {01}_{i + 1} = {SN}_{i + 1} \\ = S ( {N}_{i} + {NA}_{i} ) \\ = {SN}_{i} {NF}_{i} \\ = {N}_{i} ( 1 + \frac{( {SNIPn}_{i} + {INM}_{i} ) ( {n}_{i} - {s}_{i} )}{{MMC}_{IDC}} )$$

This applies for instruments such as CDP, for which Sensitivity S is not a common-sense concept but which strictly takes a value S=1.

Margin INMᵢ may have one value INLMᵢ for long balances and a second value INBMᵢ for short balances, agreed between end-user and account provider as part of general terms of business. However, for certain embodiments such as ETN, the value must be variable, and is determined as a function of other parameters. For SNIPn-driven ETN (ELᵢ=0):

$${INM}_{i} = [ \frac{\begin{matrix}- \frac{{C}_{i}}{{S}_{1} H} ( {DM}_{i} - {MM}_{i} ) - \\ {Λ}_{i , K} {MM}_{i} - ( ELAM + {OA}_{i} ) \frac{( {n}_{i} - {s}_{i} )}{{MMC}_{IDC}}\end{matrix}}{{SF}_{i} ( {Λ}_{i , K} + {SNIP}_{i , K} )} ]$$

where DMᵢ≧0, MMLM≧0, MMBM≦0 (as defined in Notation), ELAM≧0, OAᵢ≧0, and so INMᵢ is a charge against the instrument value.

$${C}_{i} = {C}_{{1}^{*}} {\prod }_{t = 1}^{i - 1} \{ 1 + \frac{( {D}_{t} - {DM}_{t} ) ( {n}_{t} - {s}_{t} )}{{MMC}_{IDC}} \} for i > 1$$

Proxy for holding cost EhLᵢ (externally applied SNIPn_{i,K}-based adjustment):

$${EhL}_{i} = {ExL}_{s} {\prod }_{t = 1}^{i - 1} \{ 1 + \frac{( {D}_{t} + {CM}_{t} ) ( {n}_{t} - {s}_{t} )}{{MMC}_{IDC}} \} / {\prod }_{t = 1}^{i - 1} \{ 1 + \frac{( {SNIPn}_{t} + {INM}_{t} ) ( {n}_{t} - {s}_{t} )}{{MMC}_{IDC}} \}$$

and lifetime profitability P/L of two precisely offsetting transactions:

$$P / L = {η}_{p} PV {01}_{s} H ( \begin{matrix}\begin{matrix}{ExL}_{d} - {ExL}_{s} {\prod }_{t = 1}^{i - 1} \{ 1 + \frac{( {D}_{t} + {CM}_{t} ) ( {n}_{t} - {s}_{t} )}{{MMC}_{IDC}} \} \\ where PV {01}_{d} is required to equal\end{matrix} \\ PV {01}_{s} {\prod }_{t = 1}^{i - 1} \{ 1 + \frac{( {SNIPn}_{t} + {INM}_{t} ) ( {n}_{t} - {s}_{t} )}{{MMC}_{IDC}} \}\end{matrix} )$$

and where ηₚ is the direction of the first of the two offsetting transactions.

CMᵢ (present as SCMᵢ in OIS) and INMᵢ are margins applied to Dᵢ and SNIPnᵢ respectively which will be agreed bilaterally between account providers/suppliers and their customers in the course of their commercial dealings. For example, margin CMᵢ/SCMᵢ could be that employed between a prime broker and a client in respect of a consolidated cash balance in currency IDC. These margins will generally be configured to generate positive value for market-makers.

On a practical level, suppliers are expected to employ INMᵢ more actively than SCMᵢ to extract value from positions. With respect to accuracy, we observe that short-term deposit rates such as EONIA are quoted to an accuracy of only 2 decimal places in the percent. It is expected SNIPnᵢ figures to greater accuracy will be produced; it is noted that the market here signals a high tolerance for rounding with respect to daily compounded rates. It is also noted that a SNIPᵢ figure rounded and published to the nearest one hundred thousandth of a percentage point corresponds most closely to a SNIPnᵢ figure expressed to the nearest thousandth of a percentage point.

### Appendix 01C

### OA_{I} Calculation—Single UDP

This calculation is iterative. For the first iteration, we set strike as ELᵢ₊₁ calculated prior to inclusion of this value component. We follow the Black-76 model, and denote

Strike, iteration 1=X₁≡EL_{i+1,1}

Strike, iteration c (c>1)=X_{c}≡EL_{i+1,1}+η_{I}OV_{c-1}

Implied volatility σ may take the same value used in calculating CCᵢ 5004, or may take a distinct value to account for its strike X_{c}, either directly supplied or interpolated from a supplied surface. The directly supplied figure may be calculated by adding a fixed upward adjustment to σ.

$${d}_{1} = \frac{ln ( ( {Λ}_{i , K} + {SNIP}_{i , K} ) / {X}_{c} ) + {σ}^{2} {T}_{fni} / 2}{σ \sqrt{{T}_{fni}}} , \\ {d}_{2} = \frac{ln ( ( {Λ}_{i , K} + {SNIP}_{i , K} ) / {X}_{c} ) - {σ}^{2} {T}_{fni} / 2}{σ \sqrt{{T}_{fni}}}$$

OAᵢ=OV_{c} where c is the smallest integer for which OV_{c-1}=OV_{c} at the degree of rounding employed (given the very low strike sensitivity dOV/dX, this occurs in practice after very few iterations).

Payer-Instrument (Implicit Put):

OV_{c}=X_{c}N(−d₂)−(Λ_{i,K}+SNIP_{i,K})N(−d₁)

Receiver Instrument (Implicit Call)

OV_{c}=(Λ_{i,K}+SNIP_{i,K})N(d₁)−X_{c}N(d₂)

### Appendix 02

### Financing Rate (UDPI) Expressions

$$First {SNIP}_{i , K} = {SNIF}_{i , K} + {CC}_{i , K} + {QC}_{i , K}$$

$$Then {SNIPR}_{i , K} = {Λ}_{i , K} {D}_{c} - {SNIP}_{i , K} \frac{{MMC}_{IDC}}{{n}_{i} - {s}_{i}}$$

$$and$$

$${SNIPn}_{i , K} = \frac{{SNIPR}_{i , K}}{{Λ}_{i , K} + {SNIP}_{i , K}}$$

### Appendix 02A

### Convexity-Withheld Financing Rate Expression

$${SNIFR}_{i , K} = {Λ}_{i , K} {D}_{c} - {SNIF}_{i , K} \frac{{MMC}_{IDC}}{{n}_{i} - {s}_{i}}$$

### Appendix 03

### UDPI Components

The SNIP value can be defined as the premium of the break-even fixed rate on a one-business-day arrears set/arrears paid CMS trade over the closing UDP rate input.

At the close, Λ_{i,K} is a special case of L_{c,K}=Li(P)_{c,K}+FB_{c,K} (since CB_{c,K}=0)

Now

SNIF_{i,K}=Φ_{i,K}−Λ_{i,K}

Then

SNIP_{i,K}=SNIF_{i,K}+CC_{i,K}+QC_{i,K}

FIG. 2A illustrates key stages involved in the method of evaluating the Forward Swap Premium SNIF_{i,K}. The process is described in numerous publications and is implemented by many commercially available analytics software packages. The present invention relies upon the presence and use of existing data structures, methods and systems, including date adjustment schemes (e.g. Business Day Convention, Business Centers), weighting methods (e.g. Daycount Fraction Scheme), interpolation methods (e.g. Linear, Splines for example as described in Bartels et al. (1998)) and extrapolation methods (e.g. Linear, Flat).

Curve-building: Use of FLT_{qi}¹ when t_{mmfix}<t_{close}

Live rate FLT_{qi}¹ is not directly available, since the averaging process is only conducted once per day. Describe here is a method for determining FLT_{qi}¹ and its closing value FLT_{ci}¹. FLT_{qi}¹ marks the fixing FLT_{Fi}¹ to market and also acts as the base from which to project the first fixing on tomorrow's spot-starting IRS.

In a preferred embodiment, live deposit quotes are sampled directly from a consistent & reliable contributor set. Where this is not deemed sufficient, additional instrument prices may be sought. In one embodiment of the process, a snapshot of the (two) front STIR futures contracts is taken, adjusting proportionately for the period of overlap between these contracts and the rate fixing, at the Short-Rate Fixing Time. A constant basis assumption is then applied, adding the change in the Futures-implied rate to FLT_{Fi}¹ to arrive at FLT_{qi}¹. It can also be moderated with a parallel process covering the OIS with the same maturity, with the change in OIS price acting as a further reference for calculating the deposit-rate move.

Curve-building: Post Short-Rate Fixing Time curve definition

In a preferred curve-building embodiment, FLT_{qi}¹ is used. The discount factor χ_{FLT1} is defined applicable to payments scheduled for the termination date of the deposit contract as

$$\frac{{χ}_{s 0}}{( 1 + ( {FLT}_{qi}^{1} {ω}_{FLT 1} ) )}$$

Now, consider a 1 yr Grid-Point IRS with rate Li(p)_{q,1}, quoted with annual fixed payments versus a floating index which sets FLTk times a year. The known payments under this swap are: (i) Li(p)_{q,1}Ω_{FXD1} on the fixed leg, and (ii) FLT_{Fi}¹ ω_{FLT1} on the floating leg. The discount factor at the 1 yr point is then

$${χ}_{FXDK} = \frac{{χ}_{FLT 1} ( 1 + {FLT}_{Fi}^{1} {ω}_{FLT 1} ) - {Li ( p )}_{q , K} {\sum }_{j = 1}^{K - 1} {χ}_{FXDj} {ω}_{FXDj}}{1 + {Li ( p )}_{q , K} {ω}_{FXDK}}$$

At the close, FLT_{q,i}¹=FLT_{ci}¹ and Li(p)_{q,K}=Λi_{i,K} for all K. Within this embodiment, we may handle a switch of short-rate floating indices (for example in EUR, the switch from 3 m to 6 m EURIBOR as the floating leg index for Grid-Point IRS with a maturity of 2 yrs or more) as necessary. An example calculation using this curve-building embodiment as applied to the closing curve is given in FIG. 2A.

Key stages in the calculation of Convexity Correction CC_{i,K} are shown in FIG. 2B. By design, a one basis point (1 bp) change in quote L_{c,K} results in a fixed change in instrument value V_{c,K} across all yield levels (convexity is absent):

$$\frac{d {V}_{c , K}}{d {L}_{c , K}} = 1 ; \frac{{d}^{2} {V}_{c , K}}{d {L}_{c , K}^{2}} = 0 ( \begin{matrix}c . f . \frac{d {V}_{c , K}}{d {Li}_{c , K}} \neq constant ; \\ \frac{{d}^{2} {V}_{c , K}}{d {Li}_{c , K}^{2}} \neq 0 for IRS\end{matrix} )$$

Extending the above to incorporate forward rates F_{c,K}≡Φ_{i,K}, and following Brotherton-Ratcliffe and then (1993) as amended by Haug (1998), we have

$${CC}_{i , K} = - \frac{1}{2} \frac{\frac{{d}^{2} {V}_{c , K}}{d {Φ}_{i , K}^{2}}}{\frac{d {V}_{c , K}}{d {Φ}_{i , K}}} {Φ}_{i , K}^{2} ( exp ( {σ}_{c , K}^{2} {T}_{fni} ) - 1 )$$

Values for the partial derivatives can be generated numerically or by using 3^{rd} party financial analytics libraries. In one optional embodiment, we take

$$\frac{d {V}_{c , K}}{d {Φ}_{i , K}} = - {G ( n )}_{c , K} and \frac{{d}^{2} {V}_{c , K}}{d {Φ}_{i , K}^{2}} = \frac{d {G ( n )}_{c , K}}{d {Φ}_{i , K}}$$

Key stages in the calculation of Quanto Correction QC_{i,K} are shown in FIG. 2C. Quanto instruments settle in one currency IDC while having a value determined relative to Grid-Point IRS in a second currency GIDC. Valuation of quanto options was pioneered by Denman, Karasinski & Wecker (1990) and is summarised in Haug (1998). As applied to our interest rate environment, we find

QC_{i,K}=Φ_{i,K}{exp(−ρ_{fx}σ_{fx}σ_{K}T_{fni})−1}

For quanto correlation ρ_{fx}, we consider IDC as domestic currency. GIDC is considered as the foreign currency, and we take the exchange rate to be quoted as domestic currency per foreign currency i.e. IDC/GIDC. ρ_{fx} is then the correlation between that exchange rate and the rate for the Grid-Point IRS. If strength in the domestic currency (IDC/GIDC ↓) is accompanied by falls in the Grid-Point IRS rate (F_{i,K} ↓), meaning ρ(IDC/GIDC, F_{i,K})>0, the quanto correction is negative, and vice versa.

We find in practice that the quanto correction and convexity correction for the present invention can be calculated independently, and are additive. Let us denote this new quanto-corrected forward CMS rate as Φ_{i,K,fx}: option adjustment OAᵢ is calculated using Φ_{i,K,fx} in place of Φ_{i,K}.

### Appendix 04

### Exchange of UDP for IRS

Overnight Exchange:

Decision to be notified no later than the Closing Time on day i.

Convexity-withheld holding cost calculated on day i applicable on day i+1:

$${EL ( cw )}_{i , i + 1} = {EL}_{i} + ( {SNIF}_{i} - {η}_{I} {MA}_{i} ) + {η}_{I} ( α {OA}_{i} + ELAM - β {DA}_{i} )$$

$${EL ( cw )}_{i , i + 1} = - {SNIFR}_{i} \frac{( {n}_{i} - {s}_{i} )}{{MMC}_{IDC}}$$

$$for$$

$$CDP ( {EL}_{i} = ELAM = {RAM}_{i} = 0 )$$

Vs Swap Benchmark: Let the Swap Benchmark value which applies tomorrow be Fix_{i+1,K}. Let G(s,Fix)_{i+1,K} be the unit duration determined off period i+1 Swap Benchmark values. Let the current holding cost be ELᵢ, which we take for this purpose to incorporate EhLᵢ. Let the position PV01 be PV01ᵢ.

The new IRS terms, set (except for G(s,Fix)_{i+1,K}) on day i, are as follows:

| | |
|---|---|
| Effective Date: | Sᵢ₊₁ |
| Termination Date: | s(K)ᵢ₊₁ |
| Notional: | H PV01ᵢ/G(n)_{c, i, K} |
| Fixed Rate: | Fix_{i+1, K} |
| Eff. Date Payment: | ηₚ η_{I} H PV01ᵢ/G(n)_{c, i, K} (EL(cw)_{i, i+1} − Fix_{i+1, K}) |
| | G(s, Fix)_{i+1, K} |

Fixed Rate Basis, Floating Rate Option, Floating Rate Basis all as per UDP definition.

Vs Market @ Close: Let the reference value for the Generated IRS be Λ_{i,K}. Let the current holding cost be ELᵢ, which we take for this purpose to incorporate EhLᵢ. Let the position PV01 be PV01ₛ.

The new IRS terms, set on day i, are as follows:

| | |
|---|---|
| Effective Date: | Sᵢ₊₁ |
| Termination Date: | s(K)ᵢ₊₁ |
| Notional: | H PV01ᵢ/G(n)_{c, i, K} |
| Fixed Rate: | Φ_{i, K} |
| Spot Date Payment: | ηₚ η_{I} H PV01ᵢ (ELᵢ − Λ_{i, K}) for value sᵢ where |
| | α = β = ELAM = 0 |

Fixed Rate Basis, Floating Rate Option, Floating Rate Basis all as per UDP definition

G(n)_{c,i,K} is the closing unit duration on day fₛᵢ of the “next” Grid-Point IRS (the n(0)ᵢ value of receiving one unit of currency GIDC as an annuity over the fixed leg payment dates):

Unit Duration

$${G ( n )}_{i , K} = \frac{{\sum }_{j = 1}^{K} {χ}_{nj} {ω}_{n , i , j}}{{χ}_{n 0}}$$

Intra-Day Exchange:

Decision to be notified no later than the earlier of day i Swap Benchmark Fixing Time and day i Short-Rate Fixing Time.

Where non-zero at the level of quote rounding at execution, we must apply oBₛ. Using quotes Li_{P,s}/Li_{R,s} for Grid-Point IRS and L_{B,s}/L_{A,s} for UDPs, we define the observed intra-day UDP/IRS basis oBₛ=L_{MID,s}−Li_{MID,s}, where mid-market IRS rate Li_{M,s}=(Li_{P,s}+Li_{R,s})/2 and mid-market Delta Point rate L_{M,s}=(L_{B,s}+L_{A,s})/2.

Vs Swap Benchmark: Let the Swap Benchmark value which applies today be Fix_{i,K}. Let G(s,Fix)_{i,K} be the unit delta determined off period i Swap Benchmark values. Current holding cost is ELᵢ, which we take for this purpose to incorporate EhLᵢ. Let the position PV01 be PV01ₛ.

The new IRS terms, set at exchange execution, are as follows:

| | |
|---|---|
| Effective Date: | sᵢ |
| Termination Date: | s(K)ᵢ |
| Notional: | H PV01ₛ/G(s)_{s, K} |
| Fixed Rate: | Li_{M, s} |
| Eff. Date Payment: | ηₚ η_{I} H PV01ₛ (ELᵢ − Li_{M, s} − oBₛ) |

Fixed Rate Basis, Floating Rate Option, Floating Rate Basis all as per UDP definition

G(s)_{q,K} is the live unit duration on day fₛᵢ of the “spot” Grid-Point IRS (the s(0)ᵢ value of receiving one unit of currency GIDC as an annuity over the fixed leg payment dates):

Unit Duration

$${G ( s )}_{q , K} = \frac{{\sum }_{j = 1}^{K} {χ}_{sj} {ω}_{s , i , j}}{{χ}_{s 0}}$$

### Appendix 04A

### Exchange of UDP Risk Between Embodiments

At the time of exchange, the reference price Λ_{EFE,K} is assigned to the relevant UDP(s). This may be with direct reference to a widely-used UDP (or IRS) benchmark Fix_{K} or be derived from a liquidation price P(LIQ)_{EFE} of the instrument to be liquidated according to P(LIQ)_{EFE}=η(LIQ)₁ (Λ_{EFE,K}−EL(LIQ)ᵢ). Reference price Λ_{EFE,K} is then used to determine the acquisition price P(ACQ)_{EFE} of the instrument to be acquired according to P(ACQ)_{EFE}=η(ACQ)_{I} (Λ_{EFE,K}−EL(ACQ)ᵢ). Where η(LIQ)_{I}=η(ACQ)_{I}, the original direction ηₚ of each exchanging parties position is retained. Where it is not retained, it is reversed. Position size is maintained under these processes.

### Appendix 05

### Cash Settlement

Voluntary, driven by Price-taker (ηₚ & η_{I} take sign of existing position)

HTPA=θ_{AV}HPV01_{d}ηₚ(η_{I}(Fixᵢ−ELᵢ)−EF_{C})

HTPA=θ_{AV}HPV01_{d}ηₚmax{0,η_{I}(Fixᵢ−ELᵢ)−EF_{C}}

Voluntary, Driven by Issuer/Price-Maker, Issuer/Price-Maker Repayment Amount

ITPA=θ_{AV}HPV01_{d}max{0,η_{I}(Fixᵢ−ELᵢ)+EF_{I}}

Mandatory, Market-Driven (Safeguard Termination Provision STP)

Necessary for instruments which are constrained to be strict assets of their holders (ETN).

With strict assets, holders cannot lose more than their purchase price Pₛ, which acts as margin. Should the margin (=market price P_{q}) become inadequate, the instrument is subject to mandatory early redemption (Safeguard Termination Event STE).

In one optional embodiment, margin adequacy is handled via Safeguard Termination Premium STMᵢ, which may be fixed or reset periodically according to individual contractual terms based on characteristics of the Grid-Point IRS. Then Safeguard Termination Level STLᵢ=ELᵢ+η_{I}STMᵢ. A move in UDP quote L_{q} beyond STLᵢ triggers mandatory early redemption.

In a second optional embodiment, the value of option component OAᵢ is the measure of margin adequacy. A move in UDP quote L_{q} which drives the option value above a pre-defined maximum threshold (“OTL”) causes mandatory early redemption. The level OTL could be zero at the degree of rounding employed. The option value could be its real-time project value pOA_{q} or its daily closing value OAᵢ.

Following a Safeguard Termination Event, the Issuer's repayment STPA is:

STPA=θ_{AV}HPV01_{I}max{0,η_{I}(STSR_{i,K}−ELᵢ)}

The relationship of Safeguard Termination Settlement Rate STSR_{i,K} to executable market rates immediately following an STE is governed by a set of rules and methods, which include time limits for activity and assignment rights over Hedge Contracts. STE Relevant Source (“STERS”) rate determines the occurrence of the termination event and is governed by its own set of rules and methods. The STERS rate may be from a single source or be a panel average, it may be a bid-, offer or mid-market rate, it may be executable or non-executable, and it may be instantaneous or time-averaged.

### Appendix 06

### Product Accounting

SNIP_{i,K}- & SNIPR_{i,K}-Based Instruments:

Execution Date Transaction Value:

V(T)_{q}=NIAₛ+NAssV_{q}

Subsequent Date Transaction Value:

V(T)_{q}=AB_{o,i}+UPL_{q}+AssV_{q}

SNIPn_{i,K}-Based Instruments:

$${V ( T )}_{q} = {AB}_{o , i} + {AssV}_{q}$$

$${AB}_{o , i} = - {η}_{p} PV 0 {1}_{s} {HExL}_{s} {\prod }_{t = 1}^{i - 1} \{ 1 + \frac{( {D}_{t} + {CM}_{t} ) ( {n}_{t} - {s}_{t} )}{{MMC}_{IDC}} \}$$

$${AssV}_{q} = {η}_{p} PV {01}_{s} {HL}_{q} {\prod }_{t = 1}^{i - 1} \{ 1 + \frac{( {SNIPn}_{t} + {INM}_{t} ) ( {n}_{t} - {s}_{t} )}{{MMC}_{IDC}} \}$$

AB_{—}rt_{q}=AB_{o,i}+ACI_{q}−ACW_{q}+RPL_{—}rt_{q}+IA_{—}rt_{q}+VM_{—}rt_{q}+(IM_{—}rt_{q}−IM_{—}rt_{c,i-1})

AccV_{q}=AB_{—}rt_{q}+UPL_{—}rt_{q}+AssV_{—}rt_{q}

ABxPFE_{—}rt_{q}=AB_{—}rt_{q}+MPFE(AB)_{—}rt_{q}

AccVxPFE_{—}rt_{q}=AccV_{—}rt_{q}+MPFE_{—}rt_{q}

Closing values _rt_{c,i} may be inputs to overnight roll calculation processes, the outputs from which are in turn used to seed opening values _rt_{o,i+1} on day (i+1) as follows:

AB_{o,i+1}=AB_{c,i}+MBIᵢ−ηₚ_{_{—}}rt_{c,i} η_{I} H PV01_rt_{c,i} MBAᵢ; RPL_rt_{o,i+1}=0; IA_rt_{o,i+1}=0; VM_rt_{o,i+1}=0; IM_rt_{o,i+1}=IM_rt_{c,i}; UPL_rt_{o,i+1}=UPL_rt_{c,i}; MPFE_{o,i+1}=MPFE_rt_{c,i}; ηₚ_{_{—}}rt_{o,i+1}=ηₚ_{_{—}}rt_{c,i}; PV01_rt_{o,i+1}=PV01_rt_{c,i}

IAₛ=θ_{AV} NIAₛ; IA_rt_{q}=ΣIAₛ across all trades executed in period i

VM_tc_{q}=θ_{M,E} H PV01 ηₚ η_{I}(L_{q}−ExLₛ)=θ_{M,E} H PV01 ηₚ(P_{q}−Pₛ)

ExLₛ=Λ_{c,i-1} for open positions brought into day i

VM_rt_{q}=ΣVM_tc_{q} across all trades executed in period i

IMₛ=−θ_{M,E}H PV01ₛ ICM(bp); IM_rt_{q}=−θ_{M,E}H PV01_rt_{q} ICM(bp)

UPL_tc_{q}=(1−θ_{AV}) θ_{M,I} H PV01 ηₚ η_{I} (L_{q}−EL₁)

AssV_{q}+θ_{AV} NAssV_{q}; AssV_rt_{q}=ΣAssV_{q} across all trades executed in period i

MPFEₛ=−θ_{M,I} H PV01ₛ ICM(bp); MPFE_rt_{q}=−θ_{M,I} H PV01_rt_{q} ICM(bp)

MPFE(AB)ₛ=θ_{M,AB} MPFEₛ; MPFE(AB)_rt_{q}=−θ_{M,AB} θ_{M,I} H PV01_rt_{q} ICM(bp)

### Appendix 07

### Spot/Next Securities Lending Rates SLR_{Q}

$${SLR}_{q} = \frac{{C}_{i}}{{HP}_{q}} ( {D}_{q} - {DM}_{i} ) + \frac{( {HP}_{q} - {C}_{i} )}{{HP}_{q}} ( {D}_{q} - {MM}_{i} ) - \frac{ELAM}{{P}_{q}} \frac{{MMC}_{IDC}}{{n}_{i} - {s}_{i}} ,$$

where ELAM is a fixed periodic amount.

### Appendix 08

### OIP/OIS Ticketing Requirements

A new transaction may increase, decrease, cancel or reverse an existing open instrument to create a modified instrument. Contributions on trading day fₛᵢ for value sᵢ are:

Increase, η(opn)_{I}=η(new):η(mod)_{I}=η(opn)_{I}, PV01(mod)=PV01(opn)+PV01(new), EL(mod)=(PV01(opn) EL(opn)+PV01(new)ExL(new))/PV01(mod)

Decrease, η(opn)_{I}=−η(new), PV01(opn)>PV01(new): η(mod)_{I}=η(opn)_{I}, PV01(mod)=PV01(opn)−PV01(new)

(i) Realise P&L: RPL=PV01(new) η(opn)_{I}(ExL(new)−EL(opn)), EL(mod)=EL(opn) (ii) Capitalise P&L: RPL=0, EL(mod)=(PV01 (opn) EL(opn)−PV01(new) ExL(new))/PV01(new)

Cancellation, η(opn)_{I}=−η(new), PV01(opn)=PV01(new): RPL=PV01(new) η(open)_{I} (ExL(new)−EL(open)), PV01(mod)=0, EL(mod)=η(mod)=n/a

Reversal, η(opn)_{I}=−η(new), PV01 (opn)<PV01(new): η(mod)_{I}=−η(opn)_{I}, RPL=PV01 (opn) η(opn)_{I} (ExL(new)−EL(opn)), PV01(mod)=PV01 (new)−PV01 (opn), EL(mod)=EL(new)

### APPENDIX 09

### Product Embodiments (Investment Instrument Types)

### Embodiment A

### Cash Delta Point (CDP)

Embodiment A is a funded OTC product. The position in the present instrument, registered with a CDP account provider, is financed by an opposite position in IDC cash, whose initial balance is set with reference to traded price ExLₛ. CDP account providers may process positions with reference to SNIPnᵢ, in which case the IDC cash balance adjusts daily, by application of an interest-based cost/credit attributable to the IDC balance, and the CDP balance PV01ᵢ adjusts daily, by application of a SNIPnᵢ-based rate attributable to the CDP position. This SNIPnᵢ-based CDP embodiment enables UDP risk to be traded as if it were a self-contained currency. Positions may also be processed with reference to SNIPᵢ: the IDC cash balance adjusts daily, first by application of an interest-based cost/credit attributable to the prevailing IDC balance and second by application of a SNIPRᵢ-based dividend attributable to the CDP position; the CDP balance is static (=PV01ₛ).

Each instrument CDP_{GIDC,IDC,K,QB} may be considered as a new currency. Rate L_{q} is the exchange rate between present currency CDP_{GIDC,IDC,K,QB} and prior art currency IDC. Index SNIPn_{i,K}≡SNIPn_{i,GIDC,IDC,K,QB} is the daily spot/next benchmark financing rate for CDP_{GIDC,IDC,K,QB} balances. FIG. 10C illustrates the deployment of the SNIPn_{i,K} UDPI in trading Cash Delta Point instruments for two offsetting trades executed on consecutive days.

### Embodiment B

### Margined Delta Point (MDP)

Embodiment B is a margin-traded financial product intended to integrate with margined FX trading. Methods mirror those for futures positions, save that the instruments may be supplied bi-laterally. The position in the present instrument, registered with an MDP account provider, is financed by a notional position in IDC cash, and is margined relative to traded price ExLₛ and subsequently Λ_{c,i}. MDP account providers will most commonly process positions using SNIP_{i,K} as UDPI, in which case the IDC cash balance adjusts daily while the MDP balance is static.

### Embodiment C

### iMID OIS, OIP (when Primary)/OIS (when Secondary)

Embodiment C is an (auto-extendible) bi-lateral contract most closely related to existing OIS transactions. It is designed to slot readily into current OTC IRD infrastructure. Business is expected to be conducted under an ISDA® Master agreement, and can be processed alongside conventional IRD positions. Individual trades may initiate primary processing, as with conventional IRS, although the instruments lend themselves to a simpler ongoing trade amendment process than straight IRS. Index families SNIPRᵢ and SNIPᵢ in are most likely to be employed.

### Embodiment D

### iMID Futures, FUT

Embodiment D is a margined contract for difference (“CFD”), expected to be hosted on major international and domestic futures exchanges (each an Exchange) and to possess an external identification code such as an ISIN. SNIP_{i,K} UDPIs are the preferred basis of a novel centrally-cleared daily pay/collect mechanism operated by the Exchange's clearing house.

### Embodiment E

### SwapShares, SWS & SPS

Embodiment E is a securitized CFD designed to trade on- or off-exchange in an active secondary market. It is a strict asset of its holder, and a debt obligation of its Issuer. It may be listed, may be rated, may possess an external identification code and may be lodged for settlement in major international clearing systems. These securities carry their own margin, and their leverage may vary. They may employ a conventional knock-out mechanism which gives them advantages relative to warrants. Their value evolves most naturally with reference to the SNIPᵢ index family. They may be sold short, and may be borrowed or lent in an OTC repo market.

### Embodiment F

### TRiMIDs, TRI

Instruments of Embodiment F offer total return performance. They are de-leveraged by the additional step of relating the L_{q}-indexed return to the conventional concept of a principal amount and reapplying a gearing, for example driven by the PV01 of the UDP's Reference IRS sampled at some pre-determined time(s). This is equivalent to manipulating the index components so as to generate total return measures (“T-R Indices”) for the IRS markets. These T-R Indices will capture the development of the present value of positions made up of cash (typically 100% at inception) and an L_{q}-based risk position of given scale. Index families SNIPᵢ and SNIPᵢ are most likely to be employed, with PV01 variability governed through changes to gearing G. Instruments may be listed, may be rated and may be lodged for settlement in major international clearing systems. They may trade in an active secondary market, on- or off-exchange.

### Embodiment G

### iMID ETN, ETN

Embodiment G is an unleveraged security designed to maintain ELᵢ=0. It will use the SNIPnᵢ UDPI family. It may trade on- or off-exchange in an active secondary market. It is a strict asset of its holder, and a debt obligation of its Issuer. It may be listed, may be rated, may possess an external identification code and may be lodged for settlement in major international clearing systems. They may be sold short, they may be borrowed or lent in an OTC repo market, and may themselves be the underlying for OTC CFD trades. They may employ a prior art knock-out mechanism which protects holders against the remote risk of negative long-term interest rates.

These are few examples of investment instruments that may be used and are not intended as an exhaustive list. Those skilled in the art will recognize other product embodiments.

### Appendix 10

Provision of Trigger Chance is an example of one novel real-time data stream to support use of instruments of the present invention.

Certain instruments such as SWS are subject to mandatory early termination when instrument prices decline. Information regarding the likelihood of this event may be useful to participants. One such measure is Trigger Chance TC_{q}, the probability that L_{q} breaches the Safeguard Termination Level STLᵢ for the instrument over a pre-specified horizon. In one optional embodiment, participants will be able in a suitably interactive environment such as the index calculator's internet site to specify a Trigger Chance Horizon TCH and receive an individually calculated TC_{q}(TCH) relating to that horizon. In another optional embodiment, in a display of pre-configured instrument characteristics, the horizon will have been chosen for the viewer in line with conventions established for the instrument and the associated probability will be displayed.

First, select TCH, for example 1 month. Driven by this selection, and the day fₛᵢ on which selection is made, a TCH End Date TCHEDᵢ is defined. Algorithms as defined above in the Index Calculation Process for SMFᵢ, CCᵢ, & QCᵢ are called on, substituting the S/N input rate for a S/TCH input rate and a 1 business day implied volatility input for a TCH expiry implied volatility input and substituting a S/N forward horizon for a TCH forward horizon. From this, a convexity-adjusted forward rate F(L_{q}) is derived.

In a preferred optional methodology, the likelihood of a mandatory termination event may be approximated by taking STLᵢ as the static barrier in a binary barrier cash-at-hit option. A financing rate D_{Lq} for this treatment is derived as follows:

To follow Reiner and Rubenstein (1991) as quoted in Haug (1998), proceed via a relative growth rate for forward rate F(L_{q}).

Projected growth, STLᵢ relative to F(L_{q}):

$$g ( {STL}_{i} ) = {\sum }_{t = i}^{TCHEDi - 1} ( η ( {DA}_{t} + {MA}_{t} - {OA}_{t} - {ELAM}_{t} ) )$$

Relative Financing Rate:

$${D}_{Lq} = ln \{ 1 + ( ( {L}_{q} + g ( {STL}_{i} ) ) / {L}_{q} - 1 ) ( \frac{365}{( {TCHED}_{i} - {s}_{i} )} ) \}$$

Probability:

TC_{q}=(STIᵢ/L_{q})^{(μ+λ)}N(η_{I}Z)+(STLᵢ/L_{q})^{(μ-λ)}N(η_{I}z−2η_{I}λσ_{F}√T)

where

$$μ = \frac{{D}_{Lq} - {σ}_{F}^{2} / 2}{{σ}_{F}^{2}} , λ = \sqrt{{μ}^{2}} , z = \frac{ln ( \frac{{STL}_{i }}{{L}_{q}} )}{{σ}_{F} \sqrt{T}} + λ {σ}_{F} \sqrt{T} ,$$

and T=(f_{TCHEDi}−fₛᵢ)/365

For spread instruments, where formulations differ:

$${{D}_{{SPR}_{q}} = {D}_{L ( 1 ) q , L ( 2 ) q} \\ = ln \{ 1 + ( \begin{matrix}( {L ( 1 )}_{q} + g ( {STL}_{i} ) ) / \\ L {( 1 )}_{q} - 1\end{matrix} ) ( \frac{365}{( {TCHED}_{i} - {s}_{i} )} ) \} \\ {TC}_{q} = {( \frac{STL ( m )}{{L ( 1 )}_{q}} )}^{( μ + λ )} N ( {η}_{I} z ) + \frac{STL ( m )}{{L ( 1 )}_{q}} )}^{( μ + λ )} N ( {η}_{I} z - 2 {η}_{I} {λσ}_{SPR} √ T )$$

$$where$$

$$μ = \frac{{D}_{{SPR}_{q}} - {σ}_{SPR}^{2} / 2}{{σ}_{{SPR}_{q}}^{2}} , \\ λ = \sqrt{{μ}^{2}} , \\ z = \frac{ln ( \frac{{STL ( m )}_{ }}{{L ( 1 )}_{q}} )}{{σ}_{SPR} \sqrt{T}} + λ {σ}_{SPR} \sqrt{T} , \\ STL ( m ) = {L ( 2 )}_{q} + {STL}_{i}$$

and implied spread volatility

$${σ}_{SPR} = \sqrt{{σ}_{L ( 1 )}^{2} + {[ {σ}_{L ( 2 )} \frac{{L ( 2 )}_{q}}{STL ( m )} ]}^{2} - 2 {ρσ}_{L ( 1 )} {σ}_{L ( 2 )} \frac{{L ( 2 )}_{q}}{STL ( m )}}$$

### Notation

IDC denote instrument denomination currency.

GIDC denotes Grid-Point IRS denomination currency.

V(X)_{q} denotes the intrinsic worth of X, derived from market inputs from first principles, as distinct from a price P(X)_{q} assigned by a participant or observed in the marketplace.

P(X)_{q} denotes the price of X, assigned by a participant or observed in the marketplace, as distinct from its intrinsic worth.

N(X) denotes the cumulative normal distribution function for variable X

L_{q,K} denotes the live rate for K-tenor UDP (substitute q for specific instances)

Λ_{i,K} denotes the closing rate for K-tenor UDP, and is an alternative notation for L_{c,K} to convey the significance of this value for EoD processes

Li_{q,K} denotes the live rate for K-tenor Grid-Point IRS (substitute q for specific instances)

Li(a)_{q,K} denotes the live rate for K-tenor Grid-Point IRS (substitute q for specific instances) quoted prior to the Short-Rate Fixing Time.

Li(P)_{q,K} denotes the live rate for K-tenor Grid-Point IRS (substitute q for specific instances) quoted after the Short-Rate Fixing Time.

Λi_{i,K} denotes the closing rate for K-tenor Grid-Point IRS, and is an alternative notation for Li_{c,K} and Li(p)_{c,K} to convey the significance of this value for EoD processes

F_{q,K} denotes the live projected rate for tomorrow's Grid-Point IRS.

Φ_{i,K} denotes the committed closing fixed rate for tomorrow's (NPV=0) Grid-Point IRS

σ, σ_{F} and σ_{K} denote the implied volatility for Grid-Point IRS for the appropriate horizon given the context

ρ_{fx} denotes the correlation between forward rate F_{q,K} and the IDC/GIDC exchange rate.

σ_{fx} is the implied volatility of the IDC/GIDC exchange rate.

χ_{X}≡χ_{i,X} denotes the discount factor applicable to payments scheduled for date X.

ω_{X} denotes the daycount fraction associated with a payment for period X of a swap.

Time Cycles:

“i” is a series of whole numbers from one to m, each denoting an Index-Driven Adjustment Period in chronological order from, and including, the first Index-Driven Adjustment Period up to, and including, the M^{th} Index-Driven Adjustment Period, which together constitute the Active Period. References to “period i” or “day i” should be taken to encompass operations performed on day fₛᵢ in respect of settlement date sᵢ and in respect of the calculation period commencing sᵢ and terminating nᵢ.

“j” and “k” are series of whole numbers starting from one, each representing the incidence of a periodic roll date in chronological order from, and including, the first incidence. In case the roll frequency is annual, the incidences will be anniversaries of the original date.

sᵢ=s(0)ᵢ denotes the first day of the i^{th} IDA period. s₁ denotes the first good business day for settlement in the Active Period, which may also be (but cannot precede) the Issue Date s_{ID}.

nᵢ=n(0)ᵢ denotes the last day of the i^{th} IDA period. nₘ is the last good business day for settlement in the Active Period, which may also be (but cannot post-date) the Termination Date n_{TD}).

s(j)ᵢ is the j^{th} incidence in a periodic roll schedule out of any spot settlement date sᵢ, adjusted for any applicable business day conventions and applicable financial centers.

n(j)ᵢ is the j^{th} incidence in a periodic roll schedule out of any next following settlement date n_{b}, adjusted for any applicable business day conventions and applicable financial centers.

s(K)ᵢ and n(K)ᵢ respectively denote the maturity dates for a Grid-Point IRS of constant maturity K with effective dates sᵢ and nᵢ are s(K)ᵢ, assuming annual fixed roll frequency. For swaps quoted with a fixed payment frequency of freq per annum, a subscript to k is introduced to enumerate sequential payment dates within a given year prior to the anniversary date itself.

T_{fni} denotes the period in years between fixing day fₛᵢ and fixing day fₙᵢ calculated according to an Actual/365 calendar. In an alternative embodiment, it can denote the number of trading days between fixing day fₛᵢ and fixing day fₙᵢ divided by the number of trading days per calendar year.

T_{fsq} denotes the period in years between the current time t_{now} on day fₛᵢ and the time t_{close} on day fₛᵢ calculated according to an Actual/365 calendar. In an alternative embodiment, it can denote number of hours between time t_{now} and time t_{close} divided by the number of hours between time tₒₚₑₙ and time t_{close} to get the remaining fraction of the trading day, which is then divided by 365 to give the required value expressed in years.

T_{X} is the period in years between fixing day day fₛᵢ and day X calculated according to an Actual/365 calendar.

fₛᵢ may denote (i) the (input) trade date which drives (output) spot date sᵢ or (ii) the (output) fixing date associated with (input) effective date sᵢ or (iii) the current calculation date.

fₙᵢ may denote (i) the (input) trade date which drives (output) spot date nᵢ or (ii) the (output) fixing date associated with (input) effective date nᵢ or (iii) the next calculation date.

Sense η_{I} denoted the direction of the price response in an instrument to an upward movement in UDP rate. For instruments whose price rises when rates rise, η_{I}=1; for instruments whose price falls when rates rise, η_{I}=−1. Values of η_{I} for the present instruments are tabulated in FIG. 8H.

Direction ηₚ is an attribute of a trade and/or position in an instrument. For purchases, which result in long positions in instruments, ηₚ=1. For sales, which result in short positions, ηₚ=−1.

TC_{q} denotes Trigger Chance.

MMC_{IDC} is the money market convention in IDC deposit markets.

EF_{C} is a fee, expressed as a rate, payable by the instrument holder upon exercise of their early termination rights.

EF_{I} is a fee, expressed as a rate, payable by the instrument Issuer upon exercise of their early termination rights.

AB_{o,i} is defined as a cash account balance at the open on day i. AB_{o,1}=0.

ACI_{q} is defined as external cash paid into the account during day i.

ACW_{q} is defined as cash withdrawn to external location from the account during day i.

RPL_rt_{q} is defined as the running total P&L realised from activity in iMID instruments for whom θ_{AV}=0 during day i.

IA_rt_{q} is defined as the running total invoice amount from activity in iMID instruments during day i.

VM_rt_{q} is defined as the running total change in variation margin relative to the previous close from activity in externally-margined iMID instruments during day i. This will typically be the change in unrealised P&L from FUT activity.

IM_rt_{q} is defined as the running total initial margin from activity in externally-margined iMID instruments. This will typically result from FUT activity.

AB_{c,i} is defined as the cash account balance at the close on day i.

UPL_rt_{q} is defined as the running total unrealised P&L associated with internally-margined iMID instruments for whom θ_{AV}=0 during day i.

AssV_rt_{q} is defined as the running total asset value in iMID instrument positions for whom θ_{AV}=1.

AB_{q} is defined as the live account balance on day i.

AccV_{q} is defined as the live account value on day i.

MPFE_rt_{q} is defined as the running total margin requirement from open positions in internally-margined iMID instruments.

ABxPFE_{q} is defined as the running total account balance net of MPFE_{q} during day i.

AccVxPFE_{q} is defined as the live account value net of MPFE_{q} during day i.

MBAᵢ is the overnight index-driven adjustment to the account balance for iMID instruments, which is applicable for instruments for which ε=0.

MBIᵢ is defined as the spot/next interest on the sum of the account balance AB_{c,i} and unrealised P&L UPL_{c,i}, calculated in the conventional fashion. It accounts for interest on aggregate UPL_{c,i} and replaces at account level the component MFAᵢ which applies to individual position mark-to-market.

Prefixes:

o=observed

p=projected

c=committed

r=realised

a=aggregated (i.e. not executable, basis for UDPI projections)

i=individual (potentially executable, basis for iUDPI calculations)

In certain instances, it may be desirable to make explicit the difference between the projected value of a variable at some future time, which may be useful for practitioners, and the committed value to be deployed in its contractual setting.

Subscript

No subscript=static parameters “q” denotes variables which vary continuously throughout a trading day; “i” denotes variables with a single committed value in a given period i (one value per day);

“o” denotes the opening value of a variable for a given period i (opening sample of continuous variable, one value per day);

“c” denotes the closing value of a variable for a given period i (closing sample of continuous variable, one value per day);

“s” denotes the execution value of a variable in respect of an individual transaction (one value per transaction);

“d” denotes the execution value of a variable in respect of an individual transaction which closes an open position;

“rt” denotes the combined running total value of a variable in respect of a portfolio of positions and transactions;

“B” & “A” and “P” & “R” denote Bid/Buy & Ask/Sell and Pay & Receive sides of the market price of a variable respectively.

“I” denotes an attribute of an instrument as distinct from “p” which denotes an attribute of a ticket or position.

Suffix

_rt_{q}=running total for a continuous variable on day i

_rt_{c,i}=final running total for a continuous variable at the close on day

_tc_{q}=trade contribution to running total for a continuous variable on day i

_tc_{c,i}=trade contribution to final running total for a continuous variable at the close on day i

Perspective:

Intra-Day

Overnight

### Glossary

“Active Period” is defined as the set of Index-Driven Adjustment Periods which are relevant for determining the performance of an present instrument or of a position in an present instrument, according to context.

“Adjusted Entry Level (%)” means the prevailing Entry Level ELᵢ.

“Cash instruments” are those instruments for which θ_{AV}=1, being SWS, SPS, ETN, CDP, OIS & TRI.

“CFD instruments” are those instruments for which θ_{AV}=0, being OIP, MDP & FUT.

“Deposit Accrual Factor” DAFᵢ for period i is

$$\frac{( {D}_{i} + {DM}_{i} ) ( {n}_{i} - {s}_{i} )}{{MMC}_{IDC}}$$

“Equivalent Investment (%)” means the invoice amount required under the present instrument relative to that for a conventional bond investment of equivalent rate sensitivity, calculated as P_{A,q} G(s)_{q,K}.

“Exchange-traded” signifies a trading regime involving a central order book hosted on a regulated platform. Exchange-traded business is typically cleared centrally, but may allow clearers to compete.

“Generated IRS” is defined as the Grid-Point IRS which results from exchange of a UDP instrument position.

“Grid-Point IRS” is defined as a fixed point along the swap curve which major dealers quote as a matter of routine in line with market conventions.

“Hedge Contracts” are background OTC derivative contracts executed by the launch manager to swap the Issuer's launch proceeds into its preferred liability profile

“Index-driven Adjustment Period” or “IDA period” is a calculation period within an Active Period, each running from today's spot date to tomorrow's spot date.

“Mark-to-market Accrual Factor” MAFᵢ for period i is

$$\frac{( {D}_{i} + {MM}_{i} ) ( {n}_{i} - {s}_{i} )}{{MMC}_{IDC}}$$

“Weekly DV01(%)” is the annualized percentage change in DV01 balance that a position holder would have experienced over the most recent 1 week period, calculated as

$${\prod }_{t = i - 1}^{i - x} \{ 1 + \frac{( {SNIPn}_{t} + {INM}_{t} ) ( {n}_{t} - {s}_{t} )}{{MMC}_{IDC}} \} 360 / ( {n}_{i - 1} - {s}_{i - x} ) ,$$

solving x such that sᵢ₋ₓ=sᵢ−7

“Notional Equivalent” means the principal amount of bonds of equal maturity required to match the present instrument PV01 in question, in the case of FIG. 7B being a PV01 of [symbol] 1,000, calculated as PV01 H/G(s)_{q,K}.

“Pre-Fix Grid-Point IRS” is defined as the Grid-Point IRS which results from trade execution prior to the Short-Rate Fixing Time.

“Post-Fix Grid-Point IRS” is defined as the Grid-Point IRS which results from trade execution after the Short-Rate Fixing Time.

“OTC”, an acronym for Over The Counter, signifies a trading regime in which transactions are privately negotiated in a decentralized marketplace without disclosure requirements. Business conducted OTC may or may not be centrally cleared.

“RfQ” stands for Request for Quote and denotes a secondary pricing service in which Price-takers request prices from Price-makers for proposed transactions.

“Trigger Chance” denotes the likelihood that an instrument will experience Safeguard Termination over the period in question.

“UDP Sense” η denotes directional sensitivity of a ticket/position as the product of Direction and Sense.

I claim:

1. A computer implemented method of trading fungible interest rate swap risk redenomination products comprising:
a first party executing a first transaction in a financial product over an electronic trading system with a second party in exchange for a fixed cash amount;
in the first transaction, the first party and second party agreeing on the identity, the amount, and price of the financial product, wherein the amount of the financial product is set in terms of its value sensitivity to a one basis point movement in the quoted rate for a single generic instrument, and the price bears a direct linear relationship to an executed rate being the rate quoted by the second party for said single generic instrument;
the electronic trading system determining all subsequent real-time values of the financial product and position in the financial product;
determining the fixed rate at the close of business in preparation for trading of the financial product the next day; and
the first party executing a second transaction in the financial product over an electronic trading system with a third-party, wherein the third-party may be the second party from the first transaction, in exchange for a second fixed cash amount, where in the second transaction offsets the first transaction.

2. The computer implemented method of claim 1, wherein the first party and the second party exchange or have previously exchanged settlement instructions in order to settle the transaction.

3. The computer implemented method of claim 1, wherein the first party, as a result of this first transaction, initiates an open position in the financial product which is potentially open-ended.

4. The computer implemented method of claim 1, wherein the electronic trading system determines all subsequent real-time values of the financial product and/or position in the financial product by multiplying the prevailing amount of the financial product with the sense of the financial product and with the arithmetic difference between the prevailing rate quoted for said single generic instrument and a fixed rate, each with a polarity according to the respective parties' position in the financial product.

5. The computer implement method of claim 1, wherein the fixed rate is determined once daily at the close of business in preparation for trading of the product the next day by adjusting the fixed rate of the financial product applicable for the settlement date of the first transaction by applying a contractually-binding daily-reset index value to the fixed rate within a contractually-binding formulation.

6. The computer implement method of claim 1, wherein the fixed rate is determined once daily at the close of business in preparation for trading of the product the next day by leaving the fixed rate of the position in the financial product unchanged as that applicable for the settlement date of the first transaction and applying cash adjustments using a contractually-binding daily-reset index value within a contractually-binding formulation to a parallel cash account operated in support of position in the financial product.

7. The computer implement method of claim 1, wherein the first party and the third-party agree at the execution of the second transaction that the identity of the financial product be the same as in the first transaction, the executed amount of the financial product be the same as the prevailing amount derived from the executed amount of the first transaction, the second executed price of the product and the settlement date of the transaction.

8. The computer implemented method of claim 1, wherein the executed price of the financial product in this second transaction bears a direct linear relationship to the prevailing rate quoted by the third-party for the single generic instrument.

9. The computer implemented method of claim 1, wherein the first party and the third-party exchange or have previously exchanged settlement instructions in order to settle the second transaction.

10. The computer implemented method of claim 1, wherein the first party eliminates its position in the financial product as a result of the second transaction.

11. The computer implemented method of claim 1, wherein the first party determines the combined profitability of the first transaction and the second transaction as the sum of balance changes in any cash account(s) which has(have) received or made payments in association with the two transactions or their immediate consequences.

12. The computer implement method of claim 1, wherein said fixed cash amount for each transaction is calculated by multiplying its executed amount, expressed in units of denomination currency per basis point, with its executed price, expressed in basis points, and is payable with spot value.

13. The computer implement method of claim 12, wherein said executed price for each transaction is calculated by multiplying the sense of the product with the arithmetic difference between the executed rate and the entry level of the product applicable for the settlement date of the transaction, such entry level being independent of the transaction other than its settlement date.

14. The computer implement method of claim 12, wherein the executed price is zero and the initial fixed rate of the product and/or the position in the product is set equal to the executed rate of the transaction.

15. The computer implement method of claim 1, wherein the real-time value of the product and/or position in the product is continuously convertible into a cash amount for spot settlement.

16. The computer implement method of claim 15, wherein the cash amount is determined in an active secondary market.

17. The computer implement method of claim 15, wherein the cash amount is determined at one or more discrete times throughout a day, using a primary value calculated with reference to a benchmark fixing rate for an interest rate swap through a process established at product launch.

18. The computer implement method of claim 1, wherein said open position is automatically exchangeable into a generic prior art IRS position by applying a contractually-binding daily-reset index value within a contractually-binding formulation.

19. The computer implement method of claim 18, wherein said generic IRS position is tomorrow's spot IRS with notional amount H PV01ᵢ/G(n)_{c,i,K}, fixed rate Fix_{i+1,K} and associated payment ηₚ η_{I} H PV01ᵢ/G(n)_{c,i,K} (EL(cw)_{i,i+1}−Fix_{i+1,K}) G(s,Fix)_{i+1,K} where
$${EL ( cw )}_{i , i + 1} = - {SNIFR}_{i} \frac{( {n}_{i} - {s}_{i} )}{{MMC}_{IDC}} .$$

20. The computer implement method of claim 1, wherein the amount of the product for the purpose of the real-time value and for the purpose of scaling the second transaction is a constant fixed amount equal to the executed amount of the first transaction.

21. The computer implement method of claim 1, wherein the amount of the product for the purpose of the real-time value and for the purpose of scaling the second transaction is a stepping amount whose initial value is equal to the executed amount of the first transaction and whose value is adjusted once daily.

22. The computer implement method of claim 22, wherein the daily adjustment IBAᵢ to the amount is based on a published index rate and the prevailing amount IBᵢ and is computed daily according to:
$${IBA}_{i} = {η}_{p} HPV {01}_{i} \frac{( {SNIPn}_{i} - {INM}_{i} ) ( {n}_{i} - {s}_{i} )}{{MMC}_{IDC}}$$
where SNIPn=an index rate published once daily; ηₚ=a switch having the value of 1 for a long position and a −1 for a short position; H=a scaling coefficient equal to 10,000; PV01=a prevailing instrument balance; INM=a margin optionally applied to the index rate; (n−s)/MMC_{INC}=a day count fraction; and the amount outstanding for the next day IBAᵢ₊₁ is the sum of IBᵢ and IBAᵢ.

23. The computer implement method of claim 1, wherein the open profitability resulting from the first transaction is determined by summing the fixed cash amount of the first transaction, interest on this fixed cash amount, the cash amount according to claim 5, an index-driven amount in cash for spot value, index-driven amounts for each previous period applied in cash for that period's spot value and interest on these previously-applied index-driven amounts.

24. The computer implement method of claim 24, wherein the index-driven amount MBAᵢ is based on a published index rate and the prevailing instrument amount and is computed daily according to:
MBAᵢ=(1−ε)[γ(SNIPᵢ)−(1−γ)RAIᵢ+ηₚη_{I}ELAM]

25. The computer implement method of claim 25, wherein the rate quoted for said single generic instrument used as the basis for the executed rate for the first transaction, for subsequent real-time values and for the executed rate for the second transaction is identical to a live market rate for a generic interest rate swap at the degree of rounding quoted, differing only in the time and date on which it is quoted.

26. The computer implement method of claim 1, wherein the rate quoted for said single generic instrument is equal to sum of a live market rate for a generic interest rate swap and an intra-day adjustment applied to the live market rate.

27. The computer implement method of claim 26, wherein the intra-day adjustment applied to the live market rate is an intra-day convexity basis.

28. The computer implement method of claim 26, wherein the intra-day adjustment applied to the live market rate is the sum of an intra-day convexity basis and an intra-day fixing basis.

29. The computer implement method of claim 1, wherein the fixed rate has an initial value equal to the entry level of the product applicable for the settlement date and whose value remains constant.

30. The computer implement method of claim 1, wherein the fixed rate has an initial value equal to the entry level of the product applicable for the settlement date and whose value is adjusted once daily.

31. The computer implement method of claim 1, wherein the once daily adjustment ELAᵢ to the fixed rate is based on a published index rate and is computed daily according to:
ELAᵢ=ε[γ(SNIPᵢ−η_{I}MAᵢ)+(1−γ)(SCIᵢ−RAIᵢ)+η_{I}(αOAᵢ+ELAM−βDAᵢ)]

32. The computer implement method of claim 1, wherein the result of the settlement of the first and second transactions is registered as a change to the account balances of the trading parties in the product with a third party clearing agent.

33. The computer implement method of claim 1, wherein the interest rate risk of the product and/or position in the product is convertible into a generic interest rate swap and a cash payment.

34. The computer implement method of claim 1, wherein the processing of a trade is performed by foreign exchange processing systems, wherein the foreign exchange processing system is adapted to register balances in the inventive product as if it were a new currency.

35. The computer implement method of claim 1, wherein a graphical user interface presents product information for use in electronic trading systems comprising at least one of the sequential, sequence independent and non-sequential steps of:
displaying an interest rate curve as a grid of discrete grid-point tenors K along a first axis;
displaying live market rates corresponding to the grid of discrete grid-point tenors K on a second axis;
displaying at least the position resulting from the first transaction on this grid in accordance with its reference tenor and prevailing holding cost;
for this position, displaying amongst other things its size, its direction, its notional equivalent in generic interest rate swaps, its expected daily value change, its real-time profitability, its consumption of margin, a projected periodic holding cost adjustment, a probability of mandatory early termination if applicable, and information relating to the party's trading activity in that product.
